(19) United States
(12) Patent Application Publication
(10) Pub. No.: US 2009/0182070 A1
(43) Pub. Date: Jul. 16, 2009

(54) POLYESTER FIBER AND TEXTILE PRODUCT COMPRISING THE SAME

(75) Inventors: Kouki Miyazono, Shizuoka (JP); Norio Suzuki, Shizuoka (JP); Katsuhiko Mochizuki, Shizuoka (JP)

Correspondence Address: IP GROUP OF DLA PIPER US LLP, ONE LIBERTY PLACE, 1650 MARKET ST, SUITE 4900, PHILADELPHIA, PA, 19103, US

(73) Assignee: Toray Industries, Inc., Tokyo (JP)

(21) Appl. No.: 12/088,571

(22) PCT Filed: Sep. 22, 2006
(86) PCT No.: PCT/JP2006/318814

§ 371 Date: Mar. 28, 2008

(30) Foreign Application Priority Data
Sep. 28, 2005 (JP) 2005-282884
Dec. 22, 2005 (JP) 2005-370293

(51) Int. Cl. C08K 3/04

(52) U.S. Cl. 523/523

(57) ABSTRACT

Polyester fibers comprising a polyester resin composition which contains carbon black and comprises trimethylene terephthalate units as the main repeating structural units, and having an average resistivity (P) of 1.0×10¹² [Ω/cm] or lower; and a polyester textile product at least part of which is made of the polyester fibers. The polyester fibers have high conductivity and are highly excellent in conductivity stability to humidity fluctuations. The textile product comprising the polyester fibers has excellent performances, and examples thereof include a fibrous brush.

### RELATED APPLICATIONS

This is a §371 of International Application No. PCT/JP2006/318814, with an international filing date of Sep. 22, 2006 (WO 2007/037174 A1, published Apr. 5, 2007), which is based on Japanese Patent Application Nos. 2005-282884, filed Sep. 28, 2005, and 2005-370293, filed Dec. 22, 2005.

### TECHNICAL FIELD

This disclosure relates to polyester fibers excellent in conductivity and textile products comprising the same. More specifically, the disclosure relates to polyester fibers having a conductivity excellent in stability when humidity fluctuates, and polyester textile products comprising the polyester fibers such as woven fabrics and knit fabrics and polyester textile products made by using the polyester fibers such as brushes.

### BACKGROUND

Generally, fibers comprising polytrimethylene terephthalate (hereinafter, also referred to as “PTT”), which is a polyester main repeating structural unit of that is trimethylene terephthalate, are recently paid attention to as fibers having both features of polyamide (nylon) fibers and fibers comprising a conventional polyester such as polyethylene terephthalate (hereinafter, also referred to as “PET”) or polytetramethylene terephthalate (hereinafter, also referred to as “PBT”), and in particular, have been developed as fibers having low elastic modulus and high elastic recovery factor and excellent in low temperature dyeability.

By the way, in providing functional properties to conventional and future fibers, conductivity is one of important functions. A great demand is expected in broad fields such as clothing field and various industrial fields for fibers having a conductivity, for example, by being used as clothing fibers for clean rooms or fibers for being combined, or as fibers used for parts incorporated into apparatuses, for the purpose of removing static electricity or for the purpose of providing electric charge in an apparatus. Recently, because exposure amount of electromagnetic waves has increased even in daily environment by development of electronic information equipment, especially, by development of radio terminal equipment such as potable telephones, and influence to health is worried, the cases utilizing fibers with a conductivity as raw materials for shielding electromagnetic waves also have increased as their uses, except the cases utilizing the conductivity itself.

For example, technologies relating to anti-electrostatic fibers added or copolymerized with hydrophilic compounds to PTT are proposed (refer to JP-A-11-181626 and JP-A-10-141400). In these proposals, although fibers excellent in anti-electrostatic property can be surely obtained, the level of conductivity is about 10⁸ Ω·cm at highest, and a high conductivity is not exhibited. Further, the conductivity of the fibers obtained by this technology strongly tends to depend upon an applied environment, in particular, upon a moisture rate (humidity), and therefore, a stable conductivity cannot be ensured.

Further, some technologies relating to black colored polyester fibers added with carbon black to PTT as a pigment are proposed (refer to JP-A-2003-89926, JP-A-2003-73534 and JP-A-2003-138115). However, in the technology described in JP-A-2003-89926, carbon black is added to copolymerized PET and thereto PTT is blended, and carbon black is not contained at a condition of direct contact with PTT. Therefore, a state, where carbon black is uniformly blended relatively to PTT, cannot be expected. Further, in the technology described in JP-A-2003-73534, only a small amount of carbon black is added, and in the technology described in JP-A-2003-138115, although carbon black is contained at a relatively high concentration, special carbon black adsorbed with a benzoic acid is contained, and any of these technologies merely describes general carbon black added fibers using carbon black as a pigment. Therefore, in any of JP-A-2003-89926, JP-A-2003-73534 and JP-A-2003-138115, the conductivity of carbon black is not paid attention to, there is no description with respect to prediction with conductivity and problems to be solved in a case where carbon black is added at a high concentration, and no description and no suggestion with respect to advantages due to the conductivity.

Accordingly, paying attention to substantially not considering conductivity in the above-described prior art, to provide polyester fibers having a high conductivity and excellent in conductivity stability to humidity fluctuation, and textile products such as woven fabrics or knit fabrics comprising the fibers or brushes made by using the fibers.

### SUMMARY

We therefore provide polyester fibers comprising a polyester resin composition which contains carbon black and which comprises trimethylene terephthalate units as the main repeating structural units, and the polyester fibers have an average resistivity (P) of 1.0×10¹² [Ω/Cm] or lower. Namely, the polyester fibers are formed by using the polyester resin composition in which carbon black is directly contained and whose main repeating structural units are trimethylene terephthalate units, and the average resistivity (P) as a factor representing conductivity is controlled at 1.0×10¹² [Ω/cm] or lower (namely, formed so as to exhibit an extremely high conductivity).

Preferably, the above-described polyester resin composition forms at least part of surfaces of the fibers, and whereby, the polyester fibers themselves can exhibit a high conductivity relative to electric charge in the surroundings.

Further, it is preferred that a ratio (R) (R=Q/P) of a standard deviation of resistivity (Q) to the average resistivity (P) is preferably 0.5 or less, thereby exhibiting an excellent conductivity uniformly.

Further, it is preferred that a ratio (Z) (Z=Y/X) of an average resistivity at a temperature of 10° C. and a humidity of 15% (Y) [n/cm] to an average resistivity at a temperature of 23° C. and a humidity of 55% (X) [Ω/cm] is in a range of 1-5, thereby exhibiting a conductivity stable relative to fluctuation of humidity or fluctuation of humidity and temperature.

In order to obtain such an excellent conductivity, it is preferred that various devices such as those described later are added in the production of the polyester fibers, and in particular, it is preferred that a content of carbon black in the polyester resin composition is controlled to be 15 wt. % or more and 50 wt. % or less.

A polyester textile product is a textile product at least part of which is made by using the above-described polyester fibers. For example, it can be formed as a fibrous brush made by using the above-described polyester fibers, in particular, as a brush for electrophotographic devices the demand of which has been increased recently.

In the polyester fibers, because the polyester resin composition used for forming the fibers comprises the polyester, whose main repeating structural units are trimethylene terephthalate units, contained with carbon black, differently greatly from the conventional polyesters such as a PET-group polyester whose main repeating structural units are polyethylene terephthalate or a PBT-group polyester whose main repeating structural units are tetramethylene terephthalate, it becomes possible to easily use the resin composition for forming the fibers even if the resin composition contains conductive carbon black at a high concentration. As a result, it becomes possible to obtain fibers with a high conductivity which have been difficult to obtain in the conventional technologies, the polyester fibers can be used, for example, for clothing use such as dustproof clothes, or for non-clothing use such as interior materials such as vehicle interior materials or wall materials for buildings, carpets or floor materials, and to these fibrous products, a desirable high conductivity can be given. In addition, because the resin is polyester, it has almost no water absorption or moisture absorption property, and as a result, because the humidity dependency of the conductivity is small, the conductivity is very stable. From these, the polyester fibers can be suitably used as a raw material required to remove static electricity in clothing use such as dustproof clothes, or in non-clothing use such as wall materials for buildings, carpets used inside or outside, or vehicle interior materials, and except these uses, the fibers can be suitably employed for uses requiring a high conductivity and a stability of conductivity relative to environmental fluctuation, for example, for circuit products used by regularly or frequently applying a voltage, or various fibrous brushes used for electrophotographic devices, etc.

Further, in the polyester fibers, by employing a structure as one of particularly preferred fiber structures wherein carbon black containing PTT is exposed on at least part of fiber surfaces, the standard deviation of resistivity of the fibers, that is, unevenness of the conductivity, can be suppressed very small, and a uniform conductivity can be exhibited. Further, it is possible to make the ratio between the respective temperature/humidity conditions of the middle temperature/middle humidity of a temperature of 23° C./a humidity of 55% and the low temperature/low humidity of a temperature of 10° C./a humidity of 15% very small, and by this, it becomes possible to further enhance the stability of conductivity relative to environmental fluctuation.

Furthermore, although the polyester fibers excellent in conductivity can be obtained by forming the polyester resin composition as a layer functioning the conduction for the fibers with conductivity as aforementioned, it is possible to develop this polyester resin composition for forms other than fiber forms. For example, it can be employed as a raw material for various molded materials such as films, sheets or injection molded materials, and in these cases, as compared with the conventional polyester resin compositions such as carbon black containing PET or PBT, while high conductivity and conductivity stability can be maintained, the brittleness of the resin composition itself can be improved by containing carbon black, the occurrence rate of defects such as cracks or chipping can be suppressed very small, and an excellent mechanical properties of a molded product can be obtained. Therefore, the polyester resin composition can also be suitably employed for uses requiring conductivity or antistatic property.

### BRIEF DESCRIPTION OF THE DRAWINGS

FIG. 1 is a diagram showing a schematic structure of a section of a fiber obtained in Example 15.

### EXPLANATION OF SYMBOLS

1: polyester resin composition whose main repeating structural units are trimethylene terephthalate and containing carbon black
2: polymer having an ability for forming a fiber form (polyethylene terephthalate in Example 15)

### DETAILED DESCRIPTION

A “fiber” means a fiber having a thin and long shape, and the length may be either a so-called long fiber (filament) or a so-called short fiber (staple). In a case of a short fiber, although it may have a required length in accordance with its use, when use for spinning process or electric flocking as described later is considered, the length is preferably in a range of 0.05 to 150 mm, and more preferably in a range of 0.1 to 120 mm. Further, particularly in a case used in electric flocking, the length is preferred to be in a range of 0.1 to 10 mm, and particularly preferred to be in a range of 0.2 to 5 mm.

Further, although the thickness of the fiber, that is, the diameter of a single fiber, is not particularly restricted, from the viewpoint of being capable of being employed for various uses as described later, the diameter of a single fiber is preferably 1000 μm or less, more preferably in a range of 0.1 to 200 μm, and particularly preferably in a range of 0.5 to 50 μm. In particular, in a case of being used for fibrous brushes and being incorporated into a cleaning device or an electrostatic charging device in an electrophotographic device, the diameter of a single fiber is particularly preferred to be in a range of 0.5 to 30 μm, from the viewpoint that cleaning performance or electrostatic charging performance is excellent. In a case of being used for linings of clothes or dustproof clothes, or other various clothes, the diameter of a single fiber is particularly preferred to be in a range of 0.5 to 25 μm. In a case of being used for non-clothing use such as vehicle interior materials, wall materials for buildings or mat materials such as carpets or floor materials except closing use, the diameter of a single fiber is particularly preferred to be in a range of 0.5 to 150 μm. Where, the diameter of a single fiber is determined by the method defined in item M in the examples described later.

Where, the diameter of a single fiber is defined by determination at a magnification in a range of about 100 times to about 1,000 times using an optical microscope by focusing the diameter of the fiber. At that time, the diameter of a single fiber is defined as an average value of data obtained by observing and measuring the same single fiber at least at five points apart from each other by 3 cm or more. With respect to modified cross-sectional fibers, in a cross section perpendicular to the fiber axis, ignoring a hollow portion, a longest linear line being depicted from one outer edge of the fiber to the other outer edge of the fiber is defined as a diameter of the single fiber.

Further, the cross-sectional shape of the fiber is not particularly restricted. If the cross-sectional shape of the fiber is circular, it is preferred, because a uniform fiber property and an isotropic conductivity in the fiber section can be obtained. Further, in a case where the fibers are used for a brush roller, the fibers are incorporated at a form of short fiber, woven fabric, knit fabric or non-woven fabric, and in order to increase the stiffness by providing an anisotropy in a direction for bending the fibers, or in order to exhibit a more excellent cleaning property by obtaining a better contact property with toner in an electrophotographic device described later, the cross-sectional shape of the fiber is preferred to be a flat shape, a polygonal shape, a multi-lobe shape, a hollow shape, an undefined shape, etc.

The fibers contain a polyester resin composition (hereinafter, also referred to as “PTT containing CB”), which contains carbon black (hereinafter, also referred to as “CB”) and comprises trimethylene terephthalate units as the main repeating structural units, in the fibers at least as part of the structural units. This PTT containing CB takes charge of a main conductivity in the fibers. Because the PTT containing CB is contained in at least part of the fibers, the conductivity of the fibers themselves can be controlled by the property of this PTT containing CB, and therefore, a desirable conductivity can be provided and the fibers can have a very excellent conductivity.

One of the methods for containing the PTT containing CB as at least part of the structural units, can be achieved by blend spinning the PTT containing CB and at least one selected from (1) a polymer component having a fiber forming ability except the PTT containing CB and (2) a PTT containing CB different in concentration of CB and/or polyester composed of trimethylene terephthalate as the main repeating structural units. Here, for the blend spinning, any of methods may be employed, wherein, after the PTT containing CB and at least one of the above-described (1) and/or (2) are molten separately, they are blended at an arbitrary stage prior to discharging at a condition of shear deformation during passing through a pipe, preferably, using a static mixer, or wherein, after the PTT containing CB and at least one of the above-described (1) and/or (2) are blended in advance at an arbitrary stage prior to melting, they are molten together. After melting, they may be blended at a condition of shear deformation during passing through a pipe, preferably, using a static mixer.

Because the fibers contain the PTT containing CB in the fibers at least as part of the structural units, the fibers can be formed as conjugate spun fibers in which the PTT containing CB is arranged in at least part of the fibers. From the viewpoint of exhibiting a stable conductivity small in unevenness of conductivity in the longitudinal direction of the fibers, the conjugate fibers are preferred because of the better property, although blend spun fibers are also excellent in the property.

With respect to the structure of the above-described conjugate fibers, the PTT containing CB may be exposed on at least part of the surfaces of the fibers, or the PTT containing CB may not be exposed on the surfaces of the fibers. In a case where the PTT containing CB is exposed on at least part of the surfaces of the fibers, it is very preferable because the PTT containing CB is directly contacted and a high conductivity is exhibited. Then, since a higher conductivity is exhibited as the places of the exposure of the PTT containing CB in the fiber surfaces are many and/or the area of the exposure is large, it is preferable that the PTT containing CB is present (exposed) not only at one place but also at a plurality of places of two places or more, and it is more preferable that the PTT containing CB is exposed over half or more area of the fiber surfaces. In particular, from the viewpoint that the uniformity of conductivity on the fiber surfaces and over the entire fiber surface layers is higher and more excellent as the area of the exposed PTT containing CB is larger, it is most preferable that the whole of the surfaces of the fibers is covered with the PTT containing CB. Where, although the rate of the PTT containing CB in the cross section of the fiber perpendicular to the fiber axis (in other words, in the fiber) may be appropriately set in accordance with the target use, from the viewpoint of being capable of target fiber properties (for example, strength, residual elongation, initial tensile elastic modulus, etc.) while maintaining a particularly excellent conductivity of the fibers obtained, the rate of the PTT containing CB is preferably 7 vol. % or more, and particularly preferably, 10 vol. % or more in consideration of stable production. Further, although it is preferred that the rate of the PTT containing CB is great as much as possible because the aforementioned conductivity becomes excellent, the upper limit of the rate is preferably 95 vol. % or less from the viewpoint of exhibiting a thermal resistance at a high temperature, more preferably 90 vol. % or less, and particularly preferably 80 vol. % or less in consideration of stable production. Where, the rate of the PTT containing CB in the fibers can be determined from the ratio of the area of the portion of the PTT containing CB in the section of a single fiber to the sectional area of the single fiber, and the rate determined by the method defined in item N in the examples described later is employed.

In a case where the surface layers of the fibers are all covered with the PTT containing CB, as the structure of the fibers, the polyester fibers employ (3) a case where the inner layer of the fiber comprises the same component as that of the surface layer of the fiber, namely, a case where the fiber comprises only the PTT containing CB, or (4) a case where the inner layer of the fiber comprises a polymer having a fiber forming ability except the PTT containing CB, namely, a case where the fiber is a conjugate fiber comprising conjugate components of the PTT containing CB and the component except the PTT containing CB. In the case of (3), unevenness of conductivity of the fiber itself in the section of the fiber is not present and a uniform conductivity is given, and such a state is preferred. In the case of (4), for example, the component except the PTT containing CB, which does not contain the PTT containing CB, may be provided as a component taking charge of fiber properties of the fibers, for example, strength or elongation, or may be a layer taking charge of another function which is contained with conductive agent and the like except the CB in a range that does not injure the concept, or may be one containing another functional component. Further, in conjugate fibers in the case of (4), as the shape of a core or island in the cross section of the fiber perpendicular to the fiber axis, comprising a component except the PTT containing CB, a circle or an oval may be employed, and various shapes such as a triangle, a square or other polygons may be employed. In polygons more than a triangle, usually they frequently become shapes whose corners have rounds by the behaviour of the polymer itself at the time of being molten. If the core or island is circular, in the above-described cross section of the fiber, an isotropic strength (stiffness) can be exhibited against bending, but in a shape other than a circle, for example, in an oval or a triangle, there is a case where the flexural stiffness is different depending upon the direction for bending. In particular, for example, in a case of being used for fibrous brushes as described later, because the stiffness of the fiber itself can be controlled high by setting the core or island at a shape of a triangle, a square or another polygon except a circle, the fibers can give a very high performance particularly as a cleaning brush.

On the other hand, the fibers also can employ a structure where the PTT containing CB in the fibers is not exposed on the fiber surfaces. For example, if the layer of the PTT containing CB is exposed on the fiber surfaces, depending on the use, there is a case where it is exposed to an excessive scratching, thereby causing chipping and the like, but by employing the structure where it is not exposed on the fiber surfaces, the chipping due to such a scratching does not occur. Further, it is possible to exhibit a stable conductivity by disposing the PTT containing CB in the fiber at a position with a constant thickness from the fiber surface. In a case where the PTT containing CB is not exposed on the fiber surface, the PTT containing CB present in the fiber forms a conjugate fiber with a polymer having a fiber forming ability. This PTT containing CB either may be disposed at one place in the section of the conjugate fiber, or may be disposed at a plurality of places of two or more places. In a case being disposed at a plurality of places of two or more places, it is preferred to be disposed at 100 places at highest. Further, in a case being disposed at a plurality of places of two or more places, it is preferred that the PTT containing CB is disposed so as to be equal in distance from the fiber surface.

The fibers use a polyester whose main repeating structural unit is trimethylene terephthalate (hereinafter, also referred to as “PTT group polyester”). In a case of other generally used polyesters, for example, PET group polyester or PBT group polyester, usually, if the CB is contained at a high concentration (10 wt. % or more), drawing of a yarn cannot be carried out at all because of frequent yarn breakage during melt spinning. However, we have found that, in a case of the PTT group polyester, even if the CB is contained at a lot of amount, the melt viscosity does not fluctuate greatly, and the melt spinning can be carried out with no difference from and similarly to the usual melt spinning of only PTT group polyester. By this, the production of conductive fibers with a high conductivity, which has been possible for polyamide group polymer in the conventional technologies, becomes possible by containing the CB at a high concentration similarly even for the polyester group polymer and forming the polymer as conductive fibers with a high conductivity.

The polyester whose main repeating structural unit comprises trimethylene terephthalate is a polymer whose main repeating structural unit comprises trimethylene terephthalate, which is formed by esterification of terephthalic acid, which is a carboxylic acid, and trimethylene glycol, which is an alcohol. The main repeating structural unit means that the trimethylene terephthalate units are 50 mol % or more. The component formed by the trimethylene terephthalate is preferably 80 mol % or more, and more preferably 90 mol % or more.

The polyester whose main repeating structural unit comprises trimethylene terephthalate may be copolymerized with other components in a selected range, that is, a high melt spinning performance in a case of containing the CB at a high concentration, is not damaged, and for example, a dicarboxylic compound can be copolymerized. As the dicarboxylic compound, for example, can be exemplified aromatic, aliphatic or alicyclic dicarboxylic acid such as isophthalic acid, naphthalene dicarboxylic acid, diphenyl dicarboxylic acid, anthracene dicarboxylic acid, phenanthrene dicarboxylic acid, diphenylether dicarboxylic acid, diphenoxyethane dicarboxylic acid, diphenylethane dicarboxylic acid, adipic acid, sebacic acid, 1,4-cyclohexane dicarboxylic acid, 5-sodium sulfoisophthalic acid, 5-tetrabutylphosphonium isophthalic acid, azelaic acid, dodecanedionic acid or hexahydro terephthalic acid, and their derivatives such as alkyl, alkoxy, allyl, aryl, amino, imino or halogenated compound, their additional mass, structural isomer and optical isomer. The dicarboxylic compound may be used solely, and two or more dicarboxylic compounds may be used. Further, a diol compound can be copolymerized, and as the diol compound, for example, can be exemplified aromatic, aliphatic or alicyclic diol compound such as ethylene glycol, tetramethylene glycol, pentane diol, hexane diol, 1,4-cyclohexane dimethanol, neopentyl glycol, hydroquinone, resolcinol, dihydroxybiphenyl, naphthalene diol, anthracene diol, phenanthrene diol, 2,2-bis(4-hydroxyphenyl)propane, 4,4′-dihydroxydiphenylether, bisphenol S, and their derivatives such as alkyl, alkoxy, allyl, aryl, amino, imino or halogenated compound, their additional mass, structural isomer and optical isomer. The diol compound also may be used solely, and two or more diol compounds may be used. Further, as the copolymerized component, a compound having a hydroxyl group and a carboxylic acid in a single compound, namely, a hydroxy carboxylic acid can be exemplified. As the hydroxy carboxylic acid, for example, can be exemplified aromatic, aliphatic or alicyclic hydroxy carboxylic acid such as lactic acid, 3-hydroxypropionate, 3-hydroxybutylate, 3-hydroxybutylate barylate, hydroxybenzoic acid, hydroxynaphthoic acid, hydroxyanthracene carboxylic acid, hydroxyphenanthrene carboxylic acid or (hydroxyphenyl)vinyl carboxylic acid, and their derivatives such as alkyl, alkoxy, allyl, aryl, amino, imino or halogenated compound, their additional mass, structural isomer and optical isomer. The hydroxy carboxylic compound also may be used solely, and two or more dicarboxylic compounds may be used.

Further, in the fibers, in a case where a layer other than the PTT containing CB is disposed except a case where the fiber comprises only the PTT containing CB, the layer other than the PTT containing CB comprises a polymer having a fiber forming ability as its main component. As the polymer having a fiber forming ability, for example, polyester group polymer, polyamide group polymer, polyimide group polymer, polyolefine group polymer, vinyl group polymer synthesized by addition polymerization of vinyl group (for example, polyacrylonitrile group polymer), fluorine group polymer, cellulose group polymer, silicone group polymer, aromatic or aliphatic ketone group polymer, elastomer such as natural rubber or synthetic rubber, and other various engineering plastics can be exemplified. More concretely, for example, polyolefine group polymer which is synthesized by a mechanism in which a polymer is produced from a monomer having a vinyl group by addition polymerization such as radical polymerization, anionic polymerization or cationic polymerization, and as other vinyl group polymers, polyethylene, polypropylene, polybutylene, polymethylpentene, polystyrene, polyacrylic acid, polymethacrylic acid, methyl polymethacrylate, polyacrylonitrile, polytetrafluoroethylene, polyvinylidene fluoride, polyvinylidene chloride, polyvinylidene cyanide, etc. can be exemplified. These polymers may be polymers produced by sole polymerization such as only polyethylene or only polypropylene, or may be copolymers produced by polymerization under a condition where a plurality of monomers are present, and for example, although poly(styrene-methacrylate), which is a copolymer, is produced by polymerization under a condition of the presence of styrene and methylmethacrylate, such a copolymer may be employed in a selected range.

Further, as the above-described polymer having a fiber forming ability, for example, a polyamide group polymer formed by reaction of carboxylic acid or carboxylic chloride and amine can be exemplified. Concretely, nylon 6, nylon 7, nylon 9, nylon 11, nylon 12, nylon 6,6, nylon 4,6, nylon 6,9, nylon 6,12, nylon 5,7, nylon 5,6, etc. can be exemplified. Except these, a polyamide group polymer composed of other aromatic, aliphatic or alicyclic dicarboxylic acid component and aromatic, aliphatic or alicyclic diamine component in a selected range may be employed, an aminocarboxylic compound, which has both of carboxylic acid and amino group in a single compound such as aromatic, aliphatic or alicyclic compound, may be used solely, or a polyamide group polymer copolymerized with third, fourth copolymerization components may be employed.

Further, as the above-described polymer having a fiber forming ability, for example, a polyester group polymer produced by esterification of carboxylic acid and alcohol can be exemplified. Concretely, as the polyester group polymer, for example, a polymer formed by ester bond of carboxylic compound and diol compound can be exemplified. As such a polymer, a polyester whose main repeating structural unit is ethylene terephthalate, trimethylene terephthalate, tetramethylene terephthalate, ethylene naphthalate, propylene naphthalate, tetramethylene naphthalate or cyclohexanedimethanol terephthalate, a liquid crystal polyester, whose main component is aromatic hydroxy carboxylic acid and which has a melt liquid crystal property, etc. can be exemplified.

Although it is not particularly restricted, to the polyester group polymer formed by ester bond of carboxylic compound and diol compound, another component may be copolymerized in a selected range, and for example, a dicarboxylic compound can be copolymerized. As the dicarboxylic compound, for example, can be exemplified aromatic, aliphatic or alicyclic dicarboxylic acid such as terephthalic acid, isophthalic acid, naphthalene dicarboxylic acid, diphenyl dicarboxylic acid, anthracene dicarboxylic acid, phenanthrene dicarboxylic acid, diphenylether dicarboxylic acid, diphenoxyethane dicarboxylic acid, diphenylethane dicarboxylic acid, adipic acid, sebacic acid, 1,4-cyclohexane dicarboxylic acid, 5-sodium sulfoisophthalic acid, 5-tetrabutylphosphonium isophthalic acid, azelaic acid, dodecanedionic acid or hexahydro terephthalic acid, and their derivatives such as alkyl, alkoxy, allyl, aryl, amino, imino or halogenated compound, their additional mass, structural isomer and optical isomer. The dicarboxylic compound may be used solely, and two or more dicarboxylic compounds may be used being combined in a selected range.

Further, as the copolymerized component for the polyester group polymer, a diol compound can be copolymerized. As the diol compound, for example, can be exemplified aromatic, aliphatic or alicyclic diol compound such as ethylene glycol, propylene glycol, tetramethylene glycol, pentane diol, hexane diol, 1,4-cyclohexane dimethanol, neopentyl glycol, hydroquinone, resolcinol, dihydroxybiphenyl, naphthalene diol, anthracene diol, phenanthrene diol, 2,2-bis(4-hydroxyphenyl)propane, 4,4′-dihydroxydiphenylether, bisphenol S, and their derivatives such as alkyl, alkoxy, allyl, aryl, amino, imino or halogenated compound, their additional mass, structural isomer and optical isomer. The diol compound may be used solely, and two or more diol compounds may be used.

Further, as the copolymerized component for the polyester group polymer, a compound having a hydroxyl group and a carboxylic acid in a single compound, namely, a hydroxy carboxylic acid can be exemplified. As the hydroxy carboxylic acid, for example, can be exemplified aromatic, aliphatic or alicyclic hydroxyl carboxylic acid such as lactic acid, 3-hydroxypropionate, 3-hydroxybutylate, 3-hydroxybutylate barylate, hydroxybenzoic acid, hydroxynaphthoic acid, hydroxyanthracene carboxylic acid, hydroxyphenanthrene carboxylic acid or (hydroxyphenyl)vinyl carboxylic acid, and their derivatives such as alkyl, alkoxy, allyl, aryl, amino, imino or halogenated compound, their additional mass, structural isomer and optical isomer. The hydroxy carboxylic compound may be used solely, and two or more dicarboxylic compounds may be used.

Further, the polyester group polymer may be a polymer whose main repeating unit is a hydroxy carboxylic acid having both of a hydroxyl group and a carboxylic acid in a single compound. As the polymer comprising such a hydroxy carboxylic acid, a polyester whose main repeating structural unit is a hydroxy carboxylic acid such as 3-hydroxypropionate, 3-hydroxybutylate, 3-hydroxybutylate barylate can be exemplified. Except these, as the hydroxy carboxylic acid, aromatic, aliphatic or alicyclic dicarboxylic acid or aromatic, aliphatic or alicyclic dicarboxylic diol may be used in a selected range, or a plurality of kinds of hydroxy carboxylic acids may be copolymerized.

Moreover, as the above-described polymer having a fiber forming ability, for example, a polycarbonate group polymer formed by transesterification of alcohol and carbonate derivative, a polyimide group polymer formed by cyclization condensation polymerization of carboxylic anhydride and diamine, and a polybenzoimidazol group polymer formed by reaction of dicarboxylic acid and diamine, can be exemplified. Furthermore, can be exemplified a polysulfone group polymer, a polyether group polymer, polyphenylenesulfide group polymer, a polyetheretherketone group polymer, a polyetherketoneketone group polymer, an aliphatic polyketone group polymer, and a polymer originating from a natural polymer such as a cellulose group polymer, chitin, chitosan and a derivative thereof.

Among these polymers having a fiber forming ability, from the viewpoint that the interfacial adhesive property with the PTT containing CB is good and a delamination hardly occur, polyester group polymers are preferable, and as the main repeating structural units, for example, ethylene terephthalate, trimethylene terephthalate, tetramethylene terephthalate, ethylene naphthalate, trimethylene naphthalate, tetramethylene naphthalate, polycyclohexanedimethanol terephthalate, lactic acid, etc. can be exemplified. Polytrimethylene terephthalate, whose main repeating structural unit is formed by the same trimethylene terephthalate as that of the PTT containing CB, is particularly preferable because of the particularly good interfacial adhesive property. Further, from the viewpoint that the elastic modulus and strength of obtained fibers are high and the fibers can be used for various uses, a polyester, whose main repeating structural unit is ethylene terephthalate, ethylene naphthalate, trimethylene naphthalate or tetramethylene naphthalate, is particularly preferable.

In the fibers, a polymer having a fiber forming ability selected from the above-described polymers may be used solely, and a plurality of kinds of polymers may be used together in a selected range.

As preferred carbon black contained in the polyester whose main repeating structural unit is formed from trimethylene terephthalate, for example, carbon black prepared by furnace process (hereinafter, referred to as “furnace black”), carbon black prepared by Ketjen process (hereinafter, referred to as “Ketjen black”), carbon black prepared from a raw material of acetylene gas (hereinafter, referred to as “acetylene black”), and as others, graphite, carbon fibers, etc. can be suitably used, and among these, furnace black, Ketjen black and acetylene black are preferred. It is necessary that the carbon black has a conductivity, and it is important that the conductivity of the carbon black is 5,000 [Ω·cm] or less in specific resistance. A particularly preferable range of the specific resistance is 1.0×10⁻⁶ to 500 [Ω·cm]. Where, the specific resistance is measured and determined by the method of item E in the examples described later. Further, from the viewpoint that it is preferred that the fiber property is not damaged when being contained in the fibers and it is preferred that the carbon black is not agglomerated, the size of the particles of the conductive carbon black is preferably in a range of 1 to 500 nm in mean particle diameter, and more preferably in a range of 5 to 400 nm. Here, the mean particle diameter is determined by the method of item J in the examples described later. The content of CB in the polyester whose main repeating structural unit is formed from trimethylene terephthalate, is preferably 15 wt. % or more and 50 wt. % or less, more preferably 16 wt. % or more and 40 wt. % or less, particularly preferably 16 wt. % or more and 35 wt. % or less, from the viewpoint that a high fiber forming ability is given and the properties of the fibers such as strength and elongation when conductivity is given are stable even if the CB is contained at a concentration higher than that in the conventional PET group polyester or PBT group polyester. Where, the content determined by the method of item L in the examples described later is employed as the content of CB.

As a method for containing CB in the polyester whose main repeating structural unit is formed from trimethylene terephthalate, an arbitrary method, for adding an additive to a polyester whose main repeating structural unit is formed from trimethylene terephthalate (PTT group polyester), can be employed. Concretely, can be exemplified (A) method for, after melting the PTT group polyester in an inert gas atmosphere, adding CB, and kneading it under a regular or reduced pressure condition by a kneader such as an extruder or a static mixer, (B) method for, after dry blending the PTT group polyester and CB in advance at a predetermined rate, preferably after dry blending the PTT group polyester prepared in a form of powder or particles and CB, melting the blend, and kneading it under a regular or reduced pressure condition by a kneader such as an extruder or a static mixer, (C) method for containing conductive carbon black at an arbitrary stage prior to stopping of polymerization in a usual polymerization of the PTT group polyester and kneading it, etc. Preferably the method of (A) or (B) is employed from the viewpoint that kneading can be easily achieved and the conductive carbon black and the PTT group polyester can be kneaded more finely. In particular, with respect to extruder, although a single-screw extruder or multi-screw extruder having twin screw or more can be suitable used, from the viewpoint that the conductive carbon black can be kneaded finely when the PTT group polyester and CB are kneaded, a multi-screw extruder having twin screw or more is preferably employed. With respect to the ratio (l/w) of the length (l) to the thickness (w) of the screw of the extruder, the (l/w) is preferably 10 or more from the viewpoint of improvement of kneading performance, more preferably 20 or more, and further preferably 30 or more. Further, although it is preferred that the time for kneading becomes shorter and the kneading performance is more improved as the (l/w) is greater, if the (l/w) is excessively great, the residence time becomes too long, the PTT group polyester may deteriorate, and therefore, the (l/w) is preferably 100 or less. Further, the addition of CB may be carried out by dry blending CB at a stage prior to supply to an extruder as aforementioned, or it may be mixed with the molten PTT group polyester in an extruder using a side feeder disposed to the extruder. Further, particularly with respect to a static mixer, for example, although it is not particularly restricted as long as it is a static mixing element for carrying out to divide the flow path of the molten PTT group polyester into two or more paths and join the divided paths again (one this operation from the division to the joining is referred to as one step), from the viewpoint of better kneading property, the number of the steps of the static mixer us preferably 5 or more, and more preferably 10 or more. Further, because there is a case where it cannot be incorporated in a case where it is too long, though depending upon a necessary length of the flow path, the upper limit thereof is preferably 50 steps or less.

As the polyester whose main repeating structural unit is trimethylene terephthalate which is preferable for the fibers, or as the aforementioned polymer having a fiber forming ability, a polymer having a usual viscosity for fibers can be used. For example, as to the polyester group polymer, if it is PET group polymer, the intrinsic viscosity (IV) is preferably in a range of 0.4 to 1.5, more preferably in a range of 0.5 to 1.3. Further, if the polymer is a polyester (PTT group polymer) whose main repeating structural unit is trimethylene terephthalate, the intrinsic viscosity (IV) is preferably in a range of 0.7 to 2.0, more preferably in a range of 0.8 to 1.8. Moreover, if the polymer is a PBT group polymer, the intrinsic viscosity (IV) is preferably in a range of 0.6 to 1.5, more preferably in a range of 0.7 to 1.4. In a case of a polyamide group polymer, for example, in a case of nylon 6, the intrinsic viscosity (IV) is preferably in a range of 1.9 to 3.0, more preferably in a range of 2.1 to 2.8. Where, the intrinsic viscosity (IV) or a limiting viscosity number [η] is determined by the method of item K in the examples described later.

Further, although the melt viscosity of the polyester whose main repeating structural unit is trimethylene terephthalate may be appropriately set in accordance with the content of added CB or the structure of the fiber, as to the melt viscosity of the polyester at a condition of containing CB, usually the shear viscosity at a shear rate of 12.16 [l/sec.] of the polymer at a temperature of melt spinning is employed in a range of 10 to 100,000 [Pa·sec.], preferably in a range of 50 to 10,000 [Pa·sec.]. The viscosity determined by the method of item F in the examples described later is employed as the melt viscosity.

Because the fibers may be exposed to a high temperature in accordance with the environment at the time of being used, from the viewpoint of excellent thermal resistance, the shrinkage percentage (dry heat contraction percentage) when being held for 15 minutes in the atmosphere at 160° C. is preferably 20% or lower, and particularly preferably 10% or lower. This shrinkage percentage is preferable as low as possible, and the fibers having a shrinkage percentage down to 0% can be suitably used. The shrinkage determined by the method of item G in the examples described later is employed as the shrinkage percentage.

In the fibers, from the viewpoint that the deformation at the time of being used is small in various uses such as clothing use or use for brush rollers described later, the residual elongation is preferably in a range of 5 to 100%, and particularly preferably in a range of 30 to 50%. As the residual elongation, the elongation determined by the method of item B in the examples described later is employed.

In the fibers, although the fiber property may be appropriately controlled depending upon various uses, from the viewpoint of broad applications to the various uses, the fibers preferably have an initial tensile elastic modulus of 15 to 80 cN/dtex, and in this range the fibers can be produced stably. Then, there is a further preferable initial tensile elastic modulus for a specified use, for example, in a case where the fibers are used as a member of a cleaning device incorporated into an electrophotographic device described later for scraping colorant such as toner, generally fibers with a high stiffness (having a high correlation with the initial tensile elastic modulus) is preferred, and from the viewpoint of good scraping property, the initial tensile elastic modulus is preferably in a range of 45 to 80 cN/dtex, and particularly preferably in a range of 50 to 80 cN/dtex. Here, in order to achieve an initial tensile elastic modulus of 45 cN/dtex or more which is preferable for being used as a member of a cleaning device incorporated into an electrophotographic device, when the polyester which contains CB and whose main repeating structural unit is trimethylene terephthalate (PTT containing CB) is formed as fibers containing the PTT containing CB at least as part of the structural units of the fibers, from the viewpoint of achieving a higher initial tensile elastic modulus, the fibers are preferably formed by using a polymer having a fiber forming ability except the PTT containing CB, for example, such as PET group polyester whose main repeating structural unit is ethylene terephthalate or PEN group polyester whose main repeating structural unit is ethylene naphthalate. Further, in a case where the fibers are used as a member of a charging device incorporated into an electrophotographic device as described later for providing an electric charge to a photoreceptor, or in a case where the fibers are used as a member of a cleaning device for attracting a colorant such as toner electrostatically by applying a voltage and removing the colorant, generally fibers with a low stiffness (having a high correlation with the initial tensile elastic modulus) is preferred, and the initial tensile elastic modulus is preferably in a range of 15 to 45 cN/dtex, more preferably in a range of 15 to 40 cN/dtex, and particularly preferably in a range of 15 to 35 cN/dtex. In this case, the initial tensile elastic modulus is preferable as low as possible. Here, in order to achieve an initial tensile elastic modulus of 45 cN/dtex or less, the design is possible even if the PTT containing CB is used as it is because its initial tensile elastic modulus is low, and in order to achieve a lower initial tensile elastic modulus, the fibers are formed preferably by using PTT group polyester whose main repeating structural unit is trimethylene terephthalate or PBT group polyester whose main repeating structural unit is tetramethylene terephthalate. Where, as the initial tensile elastic modulus, the tensile elastic modulus determined by the method of item B in the examples described later is employed.

In the fibers, to satisfy the shape or the properties in various uses such as clothing use or use for brush rollers described later, the breaking strength is preferably 1.0 cN/dtex or more, more preferably 1.3 cN/dtex or more, and further more preferably 2.0 cN/dtex or more. Usually, with respect to fibers composed of only a polyester group resin in which CB is contained at a high concentration in order to make high-conductivity fibers, originally it is fundamentally difficult to obtain fibers stably in a case where the conventional PET group polyester or PBT group polyester is used, even if fibers can be formed, the breaking strength is very low (less than 1.0 cN/dtex), and even if any method is employed, it has been difficult to increase the breaking strength. However, we have found that, in a case where a polyester component whose main repeating unit is trimethylene terephthalate is used as the polyester, even if CB is contained at a high concentration, fibers peculiarly high in breaking strength can be obtained. Then, although the breaking strength is preferable to be as high as possible, in consideration of productivity, the fibers with a breaking strength of 10.0 cN/dtex or less are preferably produced. As the breaking strength, one determined by the method of item B in the examples described later is employed.

In the polyester fibers, the average resistivity is 1.0×10¹² [Ω/cm] or lower. In this range of the average resistivity, to various textile products as described later, for example, clothing, wire products such as an actuator or a heating unit, a fibrous brush or fibrous brush roller comprising it, or various products incorporating them, a desirable conductivity can be given. The higher the conductivity is, the higher the average resistivity is. Namely, because of easy currency of electricity, it is necessary to provide a low average resistivity depending on uses, but from the viewpoint of the amount of conductive agent capable of being contained at maximum in the PTT containing CB, the lower limit of the average resistivity is 1.0×10⁰ [Ω/cm]. In particular, in a case where the fibers are used for a brush roller incorporated into a electrophotographic device as described later, the average resistivity is preferably in a range of 1.0×10³ to 1.0×10¹² [Ω/cm], and in accordance with the properties of the member used with the brush roller or the device, conductive fibers having an average resistivity in a range described later are employed. Further, even in wire products such as heating units, although a desired shape is employed after being made as a woven fabric or a knit fabric, the average resistivity is preferably in a range of 1.0×10¹ to 1.0×10⁷ [Ω/cm] although it may be appropriately set in accordance with a target current or voltage. As the average resistivity (P), one determined by the method of item C in the examples described later is employed.

Further, in the fibers, because it is preferred that a stable conductivity is ensured in various uses as described later, a ratio (R) (R=Q/P) of a standard deviation of resistivity (O) to the average resistivity (P) is preferably 0.5 or less, more preferably 0.4 or less, and particularly preferably 0.3 or less. As the ratio (R) is smaller, the unevenness of the conductivity in the longitudinal direction of the fiber is smaller, namely, it means that the fiber has a stable and excellent conductivity. In a case where the above-mentioned average resistivity of the conductive fibers is lower than 1.0×10⁸ [Ω/cm], it is particularly preferable that the ratio (R) is 0.2 or less. Further, it is more preferable as the ratio (R) is smaller as described above, it usually can take a value to 0.001, and in a case where there is no unevenness of the conductivity in the longitudinal direction of the fiber at all, it can take a value of 0.001 or less. As the ratio (R), one determined by the method of item C in the examples described later is employed.

Further, in the fibers, it is preferred that the performance of the conductive fibers is not changed at all even if there is a change of temperature and humidity, concretely, for example, even in a case of a wet weather such as rainy season or even in a case of a low-temperature and dry weather such as winter season. Accordingly, a ratio (Z) (Z=Y/X) of an average resistivity at a low temperature and low humidity (a temperature of 10° C. and a humidity of 15%) (Y) [Ω/cm] to an average resistivity at a middle temperature and middle humidity (a temperature of 23° C. and a humidity of 55%) (X) [0/cm] is preferably in a range of 1-5, more preferably in a range of 1-4, and particularly preferably in a range of 1-2. As the value of Y/X is closer to 1, the difference between the middle temperature and middle humidity and the low temperature and low humidity is smaller, namely, it means excellent fibers small in dependency on temperature and humidity. To be worthy of special mention, it can be achieved firstly by using the PTT group polyester to enable both of stabilizing the conductivity against variation of temperature and humidity which has not been achieved by containing CB in the conventional polyamide group fibers and containing carbon black at a high concentration which has not been achieved by the conventional polyester such as PET or PBT. As the ratio of the average resistivities, one determined by the method of item D in the examples described later is employed.

In the fibers, particularly at the time of preparing short fibers and carrying out electric flocking, from the viewpoint of being capable of processing more efficiently, the specific resistance is preferably in a range of 10⁶ to 10⁹ [Ω·cm], more preferably in a range of 10⁷ to 10⁸ [Ω·cm]. And, it is preferred to treat by a conductivity controlling agent in order to prepare the short fibers having the preferable specific resistance. As the conductivity controlling agent, for example, an aqueous solvent or an organic solvent mixed with silica group particles can be exemplified, and as the particle diameter of the silica group particles, particles having a size in a range of 1 nm to 200 μm are usually used, and a size in a range of 3 nm to 100 μm is preferred. As the specific resistance, one determined by the method of item E in the examples described later is employed.

In the fibers, a small amount of an additive, such as delustering agent, flame retarder, lubricant, antioxidant, ultraviolet ray absorbent, infrared ray absorbent, crystalline nucleus agent, fluorescent whitening agent, end group closing agent, etc., may be contained, in a selected range. In a case where the fibers are conjugate fibers as aforementioned, the above-described additive may be contained in any of the PTT containing CB and/or a polymer having a fiber forming ability except the PTT containing CB.

Further, in a desired range, the polymer having a fiber forming ability may contain CB and/or other conductive agents. Here, in order not to damage the fibers, it is important that the specific resistance of only the polymer part having the fiber forming ability is greater than the specific resistance of the part of the PTT containing CB so that the polymer having the fiber forming ability does not function as a component for mainly taking charge of conductivity while the polymer contains CB and/or other conductive agents.

Hereinafter, preferred methods for producing the fibers will be exemplified.

The fibers can be produced by employing various spinning methods of synthetic fibers such as melt spinning, dry spinning, wet spinning or dry/wet spinning. However, because it is easy and possible to contain CB in the polyester, which is disposed in the fibers and whose main repeating structural unit is trimethylene terephthalate, at a high concentration and it is possible to control the fiber shape precisely, the fibers are produced preferably by melt spinning. Then, the fibers are obtained by melt spinning after blending the PTT containing CB with the aforementioned polymer having a fiber forming ability, by conjugate spinning the PTT containing CB and the polymer having a fiber forming ability, or by melt spinning the PTT containing CB solely.

The molten and discharged fibers are cooled at a temperature of a lower glass transition temperature (Tg) among glass transition temperatures of polymer components forming the fibers (PTT containing CB or polymer having a fiber forming ability) or lower, after a treatment agent is not adhered or a treatment agent is adhered, they are drawn at a draw speed of 100 to 10,000 m/min., preferably 4,000 m/min. or lower, more preferably 3,000 m/min. or lower, further more preferably 2,500 m/min. or lower. Further, in consideration of productivity, they are drawn at a draw speed of 100 m/min. or higher, preferably 500 m/min. or higher. In the polyester whose main repeating structural unit is trimethylene terephthalate, because there is a case where the process stability deteriorates when drawn at an excessively high draw speed, most preferable speed is in a range of 500 to 2,500 m/min.

Where, the fiber number (fiber number of a yarn) of one bundle of fibers discharged from holes of a die may be appropriately selected in accordance with the target usage or the target use, and the fiber may be a single monofilament, or the fibers may be a multifilament comprising a plurality of yarns of 3,000 or less. However, from the viewpoint that fibers stable in various properties can be obtained and the fibers can be employed for various uses, the number is preferably in a range of 2 to 500, and particularly preferably in a range of 3 to 400. Further, the treatment agent to be adhered can be appropriately used in accordance with uses of the fibers, and although a water-containing or non-water-containing treatment agent can be employed here, in order to prevent a photoreceptor of an electrophotographic device using the fibers from deteriorating, the agent preferably does not contain a compound deteriorating the photoreceptor.

After the fibers are drawn as aforementioned, without winding them or after once winding them, the fibers are heated at a temperature of the lower glass transition temperature (Tg), among the glass transition temperatures of the polymers forming the fibers (PTT containing CB or polymer having a fiber forming ability)+100° C. or lower, preferably at a temperature in a range of the lower glass transition temperature (Tg)−20° C. to the higher glass transition temperature (Tg)+80° C., and they are served to a first-stage stretching at a draw ratio so that the residual elongation of the stretched yarn becomes 5 to 60%, preferably at a draw ratio so that the residual elongation of the stretched yarn becomes 30 to 50%, namely, at a draw ratio in a range of 1.1 to 3.0 times. Where, after the stretching is once carried out (namely, after the first-stage stretching is finished), a second-stage stretching at a draw ratio in a range of more than 1 time and 2 times or less may be further carried out.

After the stretching, the fibers are preferably heat treated at a temperature of not lower than a final stretching temperature and not higher than melting point (Tm). By the heat treatment at a high temperature after the stretching, fibers, higher in thermal resistance, low in the aforementioned ratio R (R=Q/P) of the standard deviation of resistivity (Q) to the average resistivity (P), and small and excellent in unevenness of conductivity in the longitudinal direction of the fibers, can be achieved. Where, as the Tg and Tm, those determined by the methods in item H in the examples described later are employed.

Further, before or after the above-described heat treatment, it is preferred to carry out a relax treatment by slightly shrinking the fibers at a shrinkage ratio of 0.9 time or more and less than 1.0 time. Also by this, fibers, higher in thermal resistance, low in the aforementioned ratio R(R=Q/P) of the standard deviation of resistivity (Q) to the average resistivity (P), and small and excellent in unevenness of conductivity in the longitudinal direction of the fibers, can be achieved.

As the above-described stretching method or the method for the heat treatment after the stretching, can be employed a contact type heater such as a heated pin-like material, roller-like material or plate-like material, a contact type bath using heated liquid, or non-contact type heat medium using heated gas, heated steam or electromagnetic wave. Among these, the contact type heater such as a heated pin-like material, roller-like material or plate-like material, or the contact type bath using heated liquid, are preferred because they are simple in structure and the heating efficiency is high, and the heated roller-like material is particularly preferable.

The fibers can be used as a woven fabric or a knit fabric, and they may be false twisted in a case where they are used for various uses. In the false twisting, without heating stretched fibers or non-stretched fibers or after heating the fibers by a heated pin-like material, roller-like material or plate-like material or by a non-contact type heater, they are false twisted by a disc-like material or a belt-like material. The stretched and false twisted fibers are preferably wound as they are or after being heat set although it is not particularly restricted. Further, the fibers may be twisted instead of the above-described false twisting.

The polyester fibers can be formed, for example, as usual textile products such as a woven fabric, a knit fabric or a nonwoven fabric, and except them, the fibers can be formed as polyester textile products using them at least as a part thereof, in a fibrous brush, a clothing, a mat, a flocked material using short fibers, a wire material capable of flowing an electric current, etc. Concrete embodiments will be described in detail hereunder.

The polyester fibers can be formed as a woven fabric using them as at least part thereof or for the whole thereof, in accordance with the use or shape to be applied. Here, for example, as a weave structure for a single cloth, can be exemplified a plain weave fabric such as a broad cloth, a voile, a lawn, a gingham, a tropical suiting, a taffeta, a shantung or a crepe de Chine, a twill such as a denim, a serge or a gaberdine, a satin cloth such as a satin or a doeskin, a mat weave such as a basket weave, a Panama cloth, a mat, a hopsack or an oxford, a rid weave such as a grosgrain, an ottoman or a hair cord, a steep twill such as a fancy twill, a herringbone or a broken twill, a reclined twill, a pointed twill, a broken twill, a skip twill, a curved twill, a fancy and figured twill, an irregular satin, a double satin, an extended satin, a satin check, a honeycomb fabric, a huckaback, a crepe weave, a Niagara, etc. Further, as a weave structure for a double cloth which is formed by making a single woven fabric by stacking two woven fabrics, can be exemplified a warp backed weave such as a pique or a matelass'e, a weft backed weave such as a bedford cord, a double weave such as a reversible figured or a hollow weave, etc. Further, as a pile fabric, can be exemplified a weft pile fabric such as a velveteen or a corduloy, a warp pile fabric such as a towel cloth or a velvet, etc. Other than those, a leno cloth such as a leno weave or a gauze weave, a figured cloth such as a dobby cloth or a jacquard cloth, etc. can be exemplified. In particular, as a woven fabric used for the woven fabric for a fibrous brush described later, a pile fabric formed as a warp pile fabric is preferred. As the form for the polyester fibers used for making the woven fabric, any form of grey yarn, twisted yarn, false twisted yarn, etc., or any form of long fiber (filament) or short fiber (staple), can be employed, and the form is not particularly restricted.

Further, the polyester fibers can be formed as a knit fabric using them as at least part thereof or for the whole thereof, in accordance with the use or shape to be applied. Here, as a structure for the knit fabric, can be exemplified a plain stitch such as a grey sheeting or a single, a rib type stitch such as a rib stitch, a purl stitch such as links, and other than those, a weft knitting such as a seed stitch, a crepe stitch, an accordion stitch, a small pattern, a lace stitch, a fleecy stitch, a half cardigan stitch, a full cardigan stitch, a ripple or a double pique, a warp knitting such as a tricot, a raschel or milanese stitch, etc, and in particular, as the knit fabric used for the fibrous brush described later, a knit fabric, in which the fleecy-stitch or pile-like fibers are raised so as to be projected from the surface of the knit fabric, is preferred. As the form for the polyester fibers used for making the knit fabric, any form of grey yarn, twisted yarn, false twisted yarn, etc., or any form of long fiber (filament) or short fiber (staple), can be employed, and the form is not particularly restricted.

Further, the polyester fibers can be formed as a nonwoven fabric using them as at least part thereof or for the whole thereof, in accordance with the use or shape to be applied. Here, as the nonwoven fabric, a nonwoven fabric formed by bonding or adhesion method such as chemical bonding, thermal bonding, needle punching, water jet punching (spun lacing), stitch bonding, felt finishing, etc. can be exemplified. As the form for the polyester fibers used for making the nonwoven fabric, any form of grey yarn, twisted yarn, false twisted yarn, etc., or any form of long fiber (filament) or short fiber (staple), can be employed, and the form is not particularly restricted.

The above-described woven fabric or knit fabric using the polyester fibers as at least part thereof may be applied with the processing such as degumming, dyeing or thermal setting carried out by a regular method. Alternatively, in a case of the above-described nonwoven fabric, may be applied, other than the above-described degumming, dyeing or thermal setting, a physical treatment such as glaze pressing, emboss pressing, compacting, softening or heat setting, a chemical treatment such as bonding, laminating, coating, soil resistant finishing, water repellent finishing, antistatic finishing, flame proofing, moth proofing, sanitary finishing or foamed resin finishing, and except them, an applied treatment such as micro wave application, ultrasonic wave application, far infrared radiation, ultraviolet radiation or low-temperature plasma application.

Further, the above-described woven fabric, knit fabric or nonwoven fabric using the polyester fibers as at least part thereof may be a fabric formed by using the polyester fibers and at least one kind of fibers selected from synthetic fibers, semi-synthetic fibers, natural fibers, etc. such as cellulose fibers, wool, silk, stretch fibers or acetate fibers. When concretely exemplified, as the cellulose fibers, natural fibers such as cotton or hemp, or cuprammonium rayon, rayon or polynosic, can be exemplified, and although the content of the polyester fibers to be mixed with these cellulose fibers is not particularly restricted, the content is preferably in a range of 0.1 to 50 wt. % in order to keep the feeling, moisture absorption property, water absorption property, antistatic property, etc. of the cellulose fibers and in order to keep the conductivity of the fibers. Further, as the wool and silk used for the mixing, usually present ones can be used as they are, and the content of the polyester fibers to be mixed with the wool or silk is preferably in a range of 0.1 to 50 wt. % in order to keep the feeling, warmth and bulkiness of the wool or in order to keep the feeling and creak of the silk and in order to keep the conductivity of the fibers. Further, the stretch fibers used for the mixing are not particularly restricted, as the stretch fibers, dry spun or melt spun polyurethane fibers can be exemplified, and except the polyurethane fibers, polyester group stretch fibers can be exemplified such as polytrimethylene terephthalate fibers, polytetramethylene terephthalate fibers or polytetramethylene terephthalate fibers copolymerized with polytetramethylene glycol, and in the mixed fabric using these stretch fibers, the content of the polyester fibers is preferably in a range of 0.1 to 50 wt. %. Further, the acetate fibers used for the mixing are not particularly restricted, they may be diacetate fibers or triacetate fibers, and the content of the fibers to be mixed with the acetate fibers is preferably in a range of 0.1 to 50 wt. % in order to keep the feeling, clearness and gloss of the acetate fibers and in order to keep the conductivity of the fibers in a selected range.

In these various mixed-type woven fabric, knit fabric or nonwoven fabric, the form of the polyester fibers and the method for the mixing are not particularly restricted, a known method can be used. For example, as the method for the mixing, a woven fabric such as a union cloth or reversible cloth using them as warp yarns or weft yarns, or a knit fabric such as a tricot or a raschel, can be exemplified, and as other methods, union twisting, doubling or entangling may be applied.

The woven fabric, knit fabric or nonwoven fabric using the polyester fibers as at least part thereof or for the whole thereof, including the above-mentioned them applied with the mixing, may be applied with dyeing. In particular, with respect to the process, after knitting or weaving, or in a case of nonwoven fabric, after forming a web and forming the nonwoven fabric by the aforementioned bonding or adhesion, it is preferred to take the steps of degumming, presetting, dyeing and final setting by a regular method. Further, in a case where the polyester fibers are formed by the PTT containing CB and a case where the polymer having a fiber forming ability is also a polyester group polymer except the PTT containing CB and it forms part of the fiber surfaces, as needed, the polyester polymer may be served to an alkali reduction treatment after degumming and before dyeing. The degumming is preferably carried out at a temperature in a range of 40 to 98° C. In particular, in a case of being mixed with stretch fibers, it is more preferred to carry out the degumming while relaxing the fabric because the elastic modulus can be increased. Although it is possible to omit one or both of the thermal settings before and after dyeing, it is preferred to carry out both in order to improve the form stability and dyeing property of the woven fabric, knit fabric or nonwoven fabric. The temperature for the thermal setting is in a range of 120 to 190° C., preferably in a range of 140 to 180° C., and the time for the thermal setting is in a range of 10 seconds to 5 minutes, preferably in a range of 20 seconds to 3 minutes.

The polyester fibers are very useful as fibers themselves because of the excellent conductivity, and as one of the fiber forms, they are used as short fibers having a length in a range of 0.05 to 150 mm as aforementioned. The short fibers are formed by cutting at a form of a sole single yarn of filament or at a form of a tow bundled with a plurality of yarns, and in particular, short fibers having a cut length in a range of 0.1 to 10 mm can be formed as a flocked material in which the fibers are flocked to a substrate by various methods, for example, such as electric flocking or spraying. In the electrically flocked material, 50% or more of the fibers flocked by the flocking are flocked almost perpendicularly to the substrate at an angle of from 10 degrees to an angle perpendicular to the substrate (namely, 90 degrees). As the short fibers used for the flocking in a selected range, except the short fibers comprising the polyester fibers, short fibers comprising other fibers, which are other polyester fibers, may be mixed and the mixed fibers may be used for the flocking. Further, the flocked material may by formed by adhering the short fibers to the substrate, and in the case employing such an adhesion, for example, the adhesion is preferably carried out by using an acrylic group, urethane group or ester group adhesive. Here, the thickness of the adhesive layer is preferably in a range of 1 to 500 μm, and the adhesive may be used at a single layer, or as needed, at a mixing condition of a plurality of kinds of adhesives or at a condition dividing the adhesive layer into a plurality of layers. Further, although the substrate used for the flocking is not particularly restricted and it may be appropriately selected in accordance with a device to be incorporated with the flocked material or the adhesive to be used, can be suitably employed a film, a sheet, a paper, a plate, a fabric, etc. comprising a synthetic resin, a natural resin, a synthetic fiber, a natural fiber, a wood, a mineral, a metal, etc., and the fibers may be flocked directly to a substrate forming a member itself in various uses such as a metal product, a synthetic or natural resin product, or a molded material. In particular, in order to enhance the affinity with the above-described adhesive, a synthetic or natural resin or metal sheet, which is treated for giving a hydrophilic property, is preferred. Then, if the substrate is a material such as the above-described film, sheet, paper, plate or fabric forming its surface and back surface, the fibers can be flocked onto both the surface and back surface, in accordance with uses or usage purpose. The flocked material may be mounted onto another substrate as its usage or for its use, or, for example, it can be used as the following conductive fibrous brush roller for giving a conductivity.

Concretely, the flocked material using the above-mentioned short fibers comprising the polyester fibers at least as its part can be formed and used as a fibrous brush using the flocked material as at least part thereof. In particular, it is preferably a fibrous brush roller formed by flocking the fibers directly to a rod material. Although the short fibers used here may be flocked by spraying the short fibers using a gas or by electric flocking when they are flocked onto the rod material, employment of electric flocking is preferred because a formation, where the fibers almost stand on the surface of the rod material, can be efficiently obtained. At that time, 50% or more of the short fibers are adhered so as to stand almost perpendicularly to the surface of the rod material at an angle of from 10 degrees to an angle perpendicular to the surface (namely, 90 degrees). As the short fibers used in a selected range, except the short fibers comprising the polyester fibers, short fibers comprising other fibers, may be mixed and the mixed fibers may be flocked. Further, the adhesive for the adhesion and flocking is not particularly restricted, for example, an acrylic group, urethane group or ester group adhesive is selected and used in accordance with uses and purpose, and here, the thickness of the adhesive layer is preferably in a range of 1 to 500 μm, and the adhesive may be used at a single layer, or as needed, at a mixing condition of a plurality of kinds of adhesives or at a condition dividing the adhesive layer into a plurality of layers. Further, the specific resistance of the fibrous brush roller itself of the above-described polyester fibrous brush roller using the short fibers of the polyester fibers as at least part thereof and flocked with them onto the rod material is preferably in a range of 10² to 10¹¹ Ω·cm.

Although a main material forming the above-described rod material may be selected appropriately in accordance with the employed use and purpose and it is selected solely or as a combination of a plurality of kinds of materials from a metal, a synthetic resin, a natural resin, a wood, a mineral, etc., in a case of being used as a member incorporated into an electrophotographic device described later, it is preferred that it mainly comprises a metal. Further, in a case where the rod material is made of a metal, it is preferred that an intermediate layer covers at least part of the metal or the entire surface of a portion required, and thereonto, the aforementioned woven fabric and/or kit fabric and/or nonwoven fabric are adhered or the short fibers are adhered and flocked. The material used as the intermediate layer mainly gives a cushion property to the rod material, or supplementally takes charge of elasticity and stiffness in a case where they cannot be achieved only by the elasticity and stiffness of the brush-like fibers, and can remarkably improve, for example, the toner removing property in a cleaning device or the toner providing property in a developing device described later. Although it is not particularly restricted, for the intermediate layer, for example, an urethane group material, an elastomer material, a rubber material, an ethylene-vinyl alcohol group material, etc., are suitably employed. The thickness of the intermediate layer is preferably in a range of 0.05 to 10 mm, and further, as needed, the aforementioned conductivity control agent or magnetism control agent may be added.

The aforementioned woven fabric, knit fabric or nonwoven fabric using the polyester fibers as at least part thereof can be formed as a fabric composite by bonding it with a substrate. In this case, in a case of woven fabric, a woven fabric having raised fibers or yarn ends on the surface of the woven fabric by pile weave or treatment, in a case of knit fabric, a knit fabric having pile-like raised fibers or a knit fabric having piles or yarn ends on the surface of the knit fabric by raising treatment, are preferred, respectively, because there is a case capable of more increasing the functions in the polyester fibrous brush roller described later. In a case where the bonding is carried out by adhesion, for example, it is carried out preferably by using an acrylic group, urethane group or ester group adhesive. Here, the thickness of the adhesive layer is preferably in a range of 1 to 500 μm, and the adhesive may be used at a single layer, or as needed, at a mixing condition of a plurality of kinds of adhesives or at a condition dividing the adhesive layer into a plurality of layers.

Further, although the substrate to be adhered is not particularly restricted and it may be appropriately selected in accordance with a device to be incorporated with the fabric composite or an adhesive to be used, can be suitably employed a film, a sheet, a paper, a plate, another fabric, etc. comprising a synthetic resin, a natural resin, a synthetic fiber, a natural fiber, a wood, a mineral, a metal, etc., and it may be adhered directly to a main body forming a member itself in various uses such as a metal product, a synthetic or natural resin product, or a molded material. Where, in particular, in order to enhance the affinity with the above-described adhesive, a synthetic or natural resin or metal sheet, which is treated for giving a hydrophilic property, is preferred. Then, if the substrate is a material such as the above-described film, sheet, paper, plate or fabric forming its surface and back surface, the fabric composite can be formed by adhering the aforementioned woven fabric, knit fabric or nonwoven fabric onto both the surface and back surface, in accordance with uses or usage purpose. The fabric composite may be mounted onto another substrate as its usage or for its use, or, for example, it can be used as the following conductive polyester fibrous brush for giving a conductivity.

The polyester fibrous brush can be formed by using the above-described woven fabric and/or knit fabric and/or nonwoven fabric comprising the polyester fibers as part thereof or as the whole thereof. In particular, a woven fabric is preferably used because it is stable in form. When a polyester fibrous brush is formed by bonding the used woven fabric and/or knit fabric and/or nonwoven fabric to the rod material, the fabric cut at a length required for the function of the rod material may be bonded and wound by one round, or the fabric cut in a slit-like form with a width corresponding to a value calculated by dividing the length of the rod material into several numbers or several tens may be bonded by winding it spirally onto the rod material. Although the bonding may be performed via fitting by providing a convex/concave form to the rod material beforehand, from the viewpoint of secure bonding, adhesion using an adhesive is preferred.

The adhesive used here may be employed appropriately in accordance with the use or purpose, various adhesives such as acrylic group, ester group or urethane group adhesives can be employed, and as needed, a conductivity control agent such as CB or a metal, or a magnetism control agent such as a metal such as iron, nickel, cobalt or molybdenum or oxides of these metals or mixtures thereof, may be added. Here, the thickness of the adhesive layer is preferably in a range of 1 to 500 μm, and the adhesive may be used at a single layer, or as needed, at a mixing condition of a plurality of kinds of adhesives or at a condition dividing the adhesive layer into a plurality of layers. Further, at a stage before the above-described woven fabric and/or knit fabric and/or nonwoven fabric is adhered, a material such as a conductive treatment agent, conductive sheet or conductive membrane having a specific resistance in a range of 10² to 10¹⁰ Ω·cm may be provided onto the adhesive surface.

Since the polyester fibers have a stable conductivity and can be controlled at a desired resistivity, it is possible to flow a weak current when applying a predetermined voltage, and various wire products can be formed. By utilizing this, as one example for example, an actuator, controlled and driven by being sent with a signal at a weak current, can be formed. With respect to the fiber length in this case, long fibers (filament) and the aforementioned short fibers are both available. Because it is possible to drive the actuator concretely, for example, by transmitting a weak current as a signal similarly to in a human muscle, the fibers can be used for an electric signal circuit of this actuator.

Further, as one example of the wire products, a heating unit can be formed by using the polyester fibers at least as prat thereof or the whole thereof. With respect to the fiber length here, long fibers (filament) and the aforementioned short fibers are both available. In a case of the heating unit, because the fibers are excellent in conductivity and they can be designed at a required average resistivity [Ω/cm], a heating unit can be formed in accordance with applied voltage, target temperature, etc. By applying a predetermined voltage, the polyester fibers function as a resistor and heat. When a heating unit is designed, for example, in a case where a small temperature elevation may be needed, it is preferred to use each of several polyester fibers as warp yarns and/or weft yarns. Alternatively, in a case where it is necessary to form the place to be warmed as a plane shape, by increasing the number of the polyester fibers to be used as the respective warp yarns or weft yarns, the temperature can be easily elevated, and ultimately, the woven fabric may be formed by using the fibers for the whole of the warp yarns and weft yarns. Where, a knit fabric may be used instead of the woven fabric. As the heating unit, a heating unit, which can be heated at a heating speed of 0.1° C./min. at lowest when a voltage of 100V is applied to both ends of the fibers or the woven fabric, can be used as a good heating unit.

The polyester fibers can be formed as a clothing using them at least as part thereof or the whole thereof. With respect to the fiber length here, long fibers (filament) and the aforementioned short fibers are both available. When formed as the clothing, for example, because of the excellent conductivity, a better comfortableness to wear can be obtained such as a condition where the occurrence of static electricity can be suppressed at the time of winter season or dry season, or because it is hard to attract dust, a dustproof clothing, such as a cloth for operation or a working cloth for producing semiconductors, can be formed. At that time, it is preferred to use each of several fibers as warp yarns and/or weft yarns. Further, as secondary effect, because a large amount of CB is contained in the polyester fibers, the thermal conductivity of the fibers increases, the fibers can be utilized as a raw material such as a cold feeling contact material which removes heat immediately after being worn or a warm feeling material which warms a human body soon after entering into a warm room from a cold outside in winter season.

The polyester fibers can be formed as a mat using them at least as part thereof or the whole thereof. As the mat, for example, a carpet or mat laid outside or inside a room or in a vehicle, a floor material, etc. can be exemplified. With respect to the fiber length here, long fibers (filament) and the aforementioned short fibers are both available. When formed as the mat, for example, because of the excellent conductivity, a better comfortableness can be obtained such as a condition where the occurrence of static electricity can be suppressed at the time of walking, or because it is hard to attract dust, the dustproof property is also excellent and it is hard to be soiled. At the time of forming a mat, it is preferred to use each of several fibers as warp yarns and/or weft yarns. Further, as secondary effect, because the polyester fibers are excellent in conductivity, they can be utilized as a heating material in winter season or in a cold place, also in consideration of the combination with the aforementioned heating unit.

The polyester fibrous brush roller using, at least as part thereof, the aforementioned woven fabric and/or knit fabric and/or nonwoven fabric which uses the polyester fibers at least as part thereof, or the polyester fibrous brush roller using, at least as part thereof, the flocked material which uses the aforementioned short fibers at least as part thereof, is suitably used, for example, as a member of a cleaning device incorporated into an electrophotographic device, originating from the conductivity of the used polyester fibers. Here, as the average resistivity (P) of the conductive fibers of the brush roller used for the cleaning device, an average resistivity of 1.0×10⁵ [Ω/cm] or higher and 1.0×10¹² [Ω/cm] or lower, particularly an average resistivity of 1.0×10⁹ [Ω/cm] or higher and 1.0×10¹² [Ω/cm] or lower, is suitably employed in accordance with the mechanism of the cleaning device. The brush roller traps and removes unnecessary substances (for example, in an electrophotographic device, residual colorant (toner) which has not been transferred, etc.) while being rotated in the cleaning device, if necessary, while being applied with electricity, and in a case using the polyester fibers, as aforementioned, because the fibers exhibit a stable conductive performance even if temperature and humidity fluctuate, the removal performance is remarkably excellent. Further, as how to use the polyester fibrous brush roller in the cleaning device, except the use for cleaning by bringing the polyester fibrous brush roller into contact directly with the photoreceptor, it is also used as a brush roller for cleaning a member for cleaning the photoreceptor (as aforementioned, there is a case where this member is a polyester fibrous brush roller, and in the conventional technology, there is a case where this member is a blade-like member), namely, a brush roller for cleaning the cleaning device itself, or it is used also as a polyester fibrous brush roller for transferring recovered unnecessary colorant (toner) to another place. Further, for the above-described cleaning device, a single polyester fibrous brush roller may be used or a plurality of brush rollers (two or more) may be used, in accordance with the purpose, effect and the mechanism of the cleaning device.

The polyester fibrous brush roller using, at least as part thereof, the aforementioned woven fabric and/or knit fabric and/or nonwoven fabric which uses the polyester fibers at least as part thereof, or the polyester fibrous brush roller using, at least as part thereof, the flocked material which uses the aforementioned short fibers at least as part thereof, is suitably used by being incorporated into an electrostatic charging device used in an electrophotographic device described later, originating from the conductivity of the used polyester fibers. As the average resistivity (P) of the conductive fibers of the brush roller incorporated into the electrostatic charging device, an average resistivity of 1.0×10⁶ [Ω/cm] or higher and 1.0×10¹¹ [C/cm] or lower is suitably employed. Although the performance of the electrostatic charging device using the brush roller depends upon the conductive performance of the brush roller, namely, the conductive property of the conductive fibers, except the essential purpose of uniformly charging the photoreceptor, it is required that the conductive property of the brush roller does not change at all against an environmental fluctuation in the electrophotographic device, namely, a fluctuation of temperature or humidity gradually changing during operation of the electrophotographic device, or temperature or humidity fluctuation due to season. For this, because the conductive property of the polyester fibers does not change at all against the above-described environmental fluctuation, an unevenness of electrostatic charging of the photoreceptor hardly occurs, and a very excellent electrostatic charging device can be realized. In addition, even if there remains residual toner on the surface of the photoreceptor of the electrophotographic device because of insufficient cleaning, since the brush roller is brush-like and it can function also as a cleaning roller, it is excellent also from the viewpoint that there is no contamination or almost no contamination at the time of developing or printing. Further, in a case of making the electrophotographic device small, because the above-described cleaning device and electrostatic charging device can be formed as a cleaning and electrostatic charging device in order to save the space without installing them separately, also from this point of view, it is remarkably excellent. Further, in the above-described electrostatic charging device, a single above-described brush roller or a plurality of brush rollers (two or more) may be used, in accordance with the purpose the mechanism.

The polyester fibrous brush roller using, at least as part thereof, the aforementioned woven fabric and/or knit fabric and/or nonwoven fabric which uses the polyester fibers at least as part thereof, or the polyester fibrous brush roller using, at least as part thereof, the flocked material which uses the aforementioned short fibers at least as part thereof, is suitably used by being incorporated into a developing device, originating from the conductivity of the used polyester fibers. The developing device in the electrophotographic device described later actualizes a latent image depicted by a laser on the surface of the photoreceptor uniformly charged by the electrostatic charging device, and because the resistivity of the brush roller does not change even against the aforementioned environmental fluctuation in the electrophotographic device, the toner for the image actualization is supplied uniformly to the photoreceptor and the image can be actualized, the developed or printed material obtained becomes a remarkably excellent material in which there is no or almost no unevenness of printing and which is very beautiful.

The polyester fibrous brush roller using, at least as part thereof, the aforementioned woven fabric and/or knit fabric and/or nonwoven fabric which uses the polyester fibers at least as part thereof, or the polyester fibrous brush roller using, at least as part thereof, the flocked material which uses the aforementioned short fibers at least as part thereof, is suitably used by being incorporated into an electrostatic removing device used in an electrophotographic device described later, originating from the conductivity of the used polyester fibers. As the average resistivity (P) of the conductive fibers of the brush roller incorporated into the electrostatic removing device, an average resistivity of 1.0×10³ [Ω/cm] or higher and 1.0×10¹² [Ω/cm] or lower is suitably employed. In particular, when used for an electrophotographic device described later, the conductive fibers of the brush roller exhibit stable and uniform electrostatic removing effect, and it is possible to further enhance the cleaning effect at the aforementioned cleaning device usually disposed after the electrostatic removing device, and besides, in a case of making the electrophotographic device small, it is possible to incorporate an electrostatic removing and cleaning device by using the brush roller, it is remarkably excellent.

As an electrophotographic device using the above-described cleaning device and/or electrostatic charging device and/or developing device and/or electrostatic removing device which is incorporated with a textile product using the polyester fibers at least as part thereof, concretely, a laser beam monochroic printer, a laser beam color printer, a monochroic or color printer using light emitting diodes, a monochroic copying machine, a color copying machine, a monochroic or color facsimile machine, a multifunctional composite machine, a word processor, etc. can be exemplified. In a device performing developing or printing by a mechanism which depicts a latent image on a photoreceptor using a laser and/or light emitting diodes and actualizes the image using toner, as aforementioned, because the polyester fibers are used, stable cleaning, electrostatic charging, developing and electrostatic removing performances are exhibited irrelevant to an environmental fluctuation, particularly, temperature or humidity fluctuation, and the obtained printed or developed material becomes very beautiful, of course, in a monochromic case, particularly, in a color case where a plurality of kinds of toners are used at a large amount, and further, it becomes possible to further increase the drive speed of the electrophotographic device, namely, to increase the printing or developing speed (number of sheets) per a unit time. Further, the electrophotographic device using the fibers may be made smaller, saved in space, saved in electricity, as aforementioned, and it is very preferable.

As aforementioned, the polyester resin composition is a polyester resin composition containing at least a main component of a polyester component whose main repeating unit is trimethylene terephthalate and containing CB, and having a conductivity with a specific resistance of 1.0×10⁴ [Ω·cm] or lower. By the condition of a polyester component whose main repeating unit is trimethylene terephthalate, even if CB is contained at a high concentration, as aforementioned, when the resin composition is formed as fibers and also when it is formed as various molded materials such as a film, a sheet or an injected material, differently from the conventional polyesters such as PET group polyester or PBT group polyester, it is very excellent in fluidity, particularly, in processing stability when processed at a high shear rate of 500 [I/sec.] or higher. Because the fluidity is excellent, a molded material stable in shape can be obtained from the polyester resin composition. Further, with respect to the fibers or films or other molded materials obtained, while high conductivity and stability of conductivity can be maintained, the brittleness of the resin itself can also be greatly improved, the rate of occurrence of defects such as cracking or chipping is very small and the mechanical properties as molded materials are excellent, and they are suitably used for the uses requiring conductivity or antistatic property. Although it is suitably used because of the excellent conductivity as long as the range of the specific resistance is 1.0×10⁴ [Ω·cm] or lower, a lower specific resistance is preferred, it is more preferable to be 1.0×10³ [Ω·cm] or lower, and particularly preferable to be 5.0×10² [Ω·cm] or lower. Further, although the specific resistance is preferable as it is lower because the conductivity is more excellent, the polyester resin composition containing CB takes a value of the specific resistance of 1.0×10⁻³ [Ω·cm] or higher.

The content of CB in the polyester resin composition is preferably 15 wt. % or more and 50 wt. % or less from the viewpoint of obtaining an excellent conductivity, more preferably 16 wt. % or more and 40 wt. % or less from the viewpoint of achieving more excellent conductivity and fluidity, and particularly preferably 16 wt. % or more and 35 wt. % or less from the viewpoint of achieving a very excellent conductivity and being able to suitably make various molded materials. Where, as the content of CB, one determined by the method of item L in the examples described later is employed.

As described above, the polyester resin composition is very excellent in fluidity. In order to evaluate the fluidity, the melt viscosity may be determined at a high shear rate of 1216 [1/sec.] by the method of item F in the examples described later. When determined at a measurement temperature and at 1216 [1/sec.], a ratio (η_{x%1k}/η_{0%1k}) of a melt viscosity of a polymer containing CB (for example, in a case of a content of conductive carbon black of X wt. %, it is referred to as (η_{x%1k}[Pa·sec])) to a melt viscosity of a polymer containing no CB (η_{0%1k}[Pa·sec]) is calculated, the polyester resin composition has a ratio of melt viscosity preferably in a range of 1≦η_{X%1k}/η_{0%1k}≦1.5, more preferably in a range of 1≦η_{X%1k}/η_{0%1k}≦1.3, particularly preferably in a range of 1≦η_{X%1k}/η_{0%1k}≦1.2.

### EXAMPLES

Hereinafter, our fibers and textile products will be explained concretely and in more detail based on examples, but they are not restricted by these examples at all. The properties in the examples were determined by the following methods.

A. Determination of Size [dtex] and Single Fiber Size [dtex]:

Fibers (multifilament) was taken by a hank by a length of 100 m, the weight (g) of the fibers taken by the hank was measured and the measured value was multiplied by 100. The average value of the data of measurements of three times was defined as the size of the fibers. As to the single fiber size, a value calculated by dividing the above-described size by the number of single fibers forming the filament was defined as the single fiber size [dtex].

B. Determination of Initial Tensile Elastic Modulus, Residual Elongation, Breaking Strength of Fibers:

Using Tensiron tensile tester (TENSIRON UCT-100) produced by Orientec Corporation, at an initial sample length of 50 mm and at a tensile speed of 400 mm/min. in a case of non-stretched yarn, and at an initial sample length of 200 mm and at a tensile speed of 200 mm/min. in a case of stretched yarn, the initial tensile elastic modulus (only for stretched yarn), the strength and the residual elongation are measured, and average values calculated from data of five measurements were defined as respective measured values. The initial tensile elastic modulus was determined from a gradient of a curve at initial tensile time by recording it on a chart paper at a chart speed of 100 cm/min. and a stress full range of 500 g.

C. Determination of Average Resistivity (P) [Ω/cm] and Ratio (R) (R=Q/P) of Standard Deviation of Resistivity (Q) to Average Resistivity (P):

The determination was carried out after a sample to be determined was held at an atmosphere of a middle temperature and a middle humidity (23° C., humidity: 55%) at least for one hour. When a yarn was run by a pair of mirror surface rollers of a conveying roller and a winding roller, using a device disposed between the rollers so that the running yarn came into contact with probes of two rod terminals connected to an insulation resistance tester “SM-8220” produced by To a DKK Corporation, at conditions where a thickness of the rod was φ2 mm, a distance between the points of yarn contact to the rod terminals was 2.0 cm, an applied voltage was 100V, a yarn running speed was 60 cm/min., and a yarn tension at a position between the rollers was in a range of 0.05 to 0.1 cN/dtex (in this range, there is no difference between measured data), resistances were measured by a length of 120 cm at a sampling rate at the insulation resistance tester of 0.2 sec., and the value calculated by dividing the average value of the obtained data [Ω] by the distance of the points of yarn contact between the rod terminals (2.0 cm) was defined as the average resistivity (P) [Ω/cm]. Further, after the standard deviation (Q) of all resistivities obtained at the same time was calculated, the ratio (R) (R=Q/P) of (Q) to (P) was calculated.

D. Determination of Ratio (Z) (Z=Y/X) (Temperature and Humidity Fluctuation: Z) of Average Resistivity at Low Temperature and Low Humidity (10° C., Humidity: 15%) (Y) to Average Resistivity at Middle Temperature and Middle Humidity (23° C., Humidity: 55%) (X):

As to the middle temperature and middle humidity, the method of item C was employed, and also in the low temperature and low humidity, the average resistivity was determined in a manner similar to the method of item C, and the ratio (Z) (Z=Y/X) was determined from the respectively obtained average resistivities (X) and (Y).

E. Method for Determining Specific Resistance:

The determination was carried out after a sample to be determined was held in an atmosphere of the above-described middle temperature and middle humidity at least for one hour. In a case where the object to be determined was a fibrous material having a length of 100 mm or more, the fiber bundle was set at a bundle of 1,000 dtex and it was cut at a length of 50 mm (at that time, the fiber end surfaces were cut obliquely), and after a conductive paste was applied to the end surfaces, electrodes were attached thereto, and the determination was carried out at 500V. In a case where the object to be determined was a fibrous material or a powder-like material having a length less than of 100 mm, it was determined after charging it at a pressure of 10 MPa into box-type container composed of an insulation material having a length of 10 cm, a width of 2 cm and a depth of 1 cm and having electrodes on both end surfaces and closing the container, and the determined data was converted into a specific resistance per a unit volume [Ω·cm]. In a case of a gut-like material, in one determination, as to a gut having a diameter D (in a range of 0.2 to 0.3 cm) and a length of 12 cm, using a tester, two terminals of the tester were pressed to the gut at an arbitrary 10 cm distance, the resistance R [Ω] was measured, and the specific resistance of the gut was determined from the equation of (specific resistance)=R×(D/2)²×π/10. As to five different guts, one determination of the specific resistance was carried out for each gut, and an average value of the five determinations was defined as the specific resistance of the gut.

F. Determination of Melt Viscosity:

Using “Capilograph 1B” produced by Toyo Seiki Corporation, the melt viscosity was determined in a nitrogen atmosphere at a barrel diameter of 9.55 mm, a nozzle length of 10 mm, a nozzle inner diameter of 1 mm, a polymer extruding piston speed of 1 mm/min. (shear rate of 12.16 [I/sec.]) or 100 mm/min. (shear rate of 1216 [1/sec.]) after 10 minutes had passed from sample charging. An average value of data of five determinations was defined as the melt viscosity at each shear rate.

G. Calculation of Shrinkage (Dry Thermal Shrinkage) in Atmosphere of 160° C. for 15 Minutes:

One clip was fastened to a bundle formed by taking five rings of stretched yarns each having a length of 1 m by a hank, and the length L1 of the bundle was measured (in this case, about 500 mm). Next, the bundle was slowly moved down into an atmosphere having a temperature of 160° C. and placed stationarily, and after 15 minutes, it was taken out and dried by air for one hour or more. After the air drying, the length L2 of the bundle was measured again. The shrinkage (%) is calculated by the following equation.

dry thermal shrinkage(%)={(L1−L2)÷L1}×100

H. Determination of Glass Transition Temperature (Tg) and Melting Point (Tm):

Using a differential scanning calorimeter (DSC-2) produced by Perkin Elmer Corporation, a sample of 10 mg was determined at a temperature elevation speed of 16° C./min. The definition of Tm and Tg is as follows. After an endothermic peak temperature (Tm₁) observed when once measured at a temperature elevation speed of 16° C./min. was determined, the sample was held at a temperature of about (Tm+20)° C. for 5 minutes and then rapidly cooled down to a room temperature (the rapid cooling time and the room temperature holding time were totally 5 minutes), and when determined at a temperature elevation speed of 16° C./min. again, an endothermic peak temperature observed as a stepped shift of a standard line was defined as the Tg, and an endothermic peak temperature observed as a crystalline melting temperature was defined as the Tm.

I. Determination of Fiber Length of Short Fiber:

For short fibers having a length of 20 mm or more, at conditions of applying a load of 0.1 g/dtex and using calipers, and for short fibers having a length less than 20 mm, at conditions of using “SHADOW GRAPH Model 16” produced by Nippon Kogaku K.K. and a magnification of 20 times, the lengths of 50 short fibers were determined, and an average value thereof was defined as the fiber length.

J. Confirming of Average Particle Diameter of Carbon Black (CB):

A block formed by embedding fibers or a resin in an epoxy resin was dyed using ruthenium oxide solution, it was cut by an ultramicrotome to prepare an extremely thin piece having a thickness in a range of 60 to 100 nm, it was observed by a transmission type electron microscope (TEM) (produced by Hitachi Co., Ltd., type: H-7100FA) at an acceleration voltage of 75 kV and at an arbitrary magnification in a range of 20,000 to 100,000 times, and the obtained photograph was digitized at a black and white condition. By image analyzing CB portions observed as black in the photograph using a computer software of “Win ROOF” (version 2.3) produced by Mitsutani Shoji Corporation, an average particle diameter was confirmed. As to the average particle diameter of CB, the areas of all CB portions present on the photograph were calculated, respectively, and the average particle diameter was calculated as an average value of diameters of CB calculated from the areas by determining the CB portions to be schematically circular.

K. Determination of Intrinsic Viscosity (IV) and Limiting Viscosity Number [η]:

In a case of polyester group polymer, a sample was dissolved in an orthochlorophenol solution, and they were determined at 25° C. using an Ostwald viscometer. In a case of polyamide group polymer, a sample was dissolved in a formic acid, and they were determined in a manner similar to that for polyester group polymer.

L. Content of Conductive Agent in Polyester:

In a case where the content of conductive agent was determined for fibers formed only by a resin composition containing conductive agent, after a calibration curve was prepared beforehand using a spectrophotometer “U-3010” produced by Hitachi High Technologies Corporation and using 5 kinds of solutions with concentrations different from each other whose concentrations of conductive agents were known (solvent for dissolving polyester: for example, in a case of polylactic acid, chloroform, and in a case of PET group polyester, PTT group polyester or PBT group polyester, hexafluoro isopropanol), the content of conductive agent in the resin composition containing conductive agent was determined. In a case of conjugate fibers, the content of conductive agent was calculated from a rate of a resin composition containing conductive agent which was determined by item N described later. In a case of polyester insoluble or hardly soluble to solvent, the content was determined by stirring the polyester in sodium hydride aqueous solution of 1N at 30° C. for 24 hours, and after carrying out centrifugal separation, weighing the amount of conductive agent.

Determination of Diameter of Single Fiber:

Using a scanning type electron microscope (SEM) “STRATA DB235” produced by FEI Company, after a platinum-palladium deposition treatment (thickness of deposited membrane: 25-50 angstroms) was carried out at an acceleration voltage of 2 kV, the diameter was observed at a magnification capable of entering the entire outer diameter of the fiber into the visual field (5,000 times for a diameter of single fiber in a range of 25-50 μm, 10,000 times for a range of 15-25 μm, and 20,000 times for a range of 5-15 μm). Where, at that time, the diameter of single fiber was defined as an average value calculated from the data obtained by observing and measuring at least arbitrary 5 points in the same fiber at an interval of 3 cm or more.

N. Calculation of Rate of Polyester Containing Carbon Black and Comprising Trimethylene Terephthalate as Main Repeating Structural Units (PTT Containing CB) in Fibers:

A block formed by embedding filaments of fibers to be served to the calculation of the rate in an epoxy resin was cut by a microtome in a fiber cross-sectional direction perpendicular to a fiber axial direction to prepare a thin piece, after it was observed and a photograph was taken by an optical microscope at a magnification of 200 times using transmitted light, in the obtained photograph of the cross section of the fiber, by image analyzing the area of the portions of PTT containing CB and the area of other portions, respectively, using the aforementioned “Win ROOF”, the rate was calculated.

### Comparative Example 1

### Method for Producing Polyethylene Terephthalate, Preparation of Polyethylene Terephthalate Component Added with CB, Production of Fibers

To a low grade polymer prepared by a usual esterification from terephthalic acid of 166 parts by weight and ethylene glycol of 75 parts by weight, phosphoric acid 85% aqueous solution of 0.03 part by weight as an anticolorant, antimony trioxide of 0.06 part by weight as a condensation polymerization catalyst and cobalt acetate tetrahydrate of 0.06 part by weight as a color control agent were added to carry out condensation polymerization, thereby obtaining usually used polyethylene terephthalate (hereinafter, PET) pellets having an IV of 0.67, a melt viscosity of 181 [Pa·sec.] (measurement temperature: 290° C., 12.16 [1/sec.]) and a melting point (Tm) of 256° C.

After the pellets were vacuum dried at 150° C. for 10 hours, and after formed as powder material in a nitrogen atmosphere, before it was melt kneaded using a twin screw extruder (screw length L/screw diameter D=45), with the above-described powder, CB powder of furnace black produced by Cabot Specialty Chemicals, Inc. (type “VULCAN XC72”, specific resistance: 0.45 [Ω·cm], average diameter: 31 nm, hereinafter, “FCB”) was mixed at a condition of powder in a nitrogen atmosphere, and thereafter, they were molten and kneaded by the twin screw extruder. Where, FCB was prepared so that the content of FCB in the resin composition of PET and FCB obtained after completion of the kneading became 16 wt. %, and the kneading was carried out at 280° C. After kneading, the discharged gut-like resin composition was cut by a cutter after being cooled by service water at 15° C., thereby obtaining pellets of the resin composition of PET and FCB (hereinafter, PET-FCB) having a melt viscosity of 1341 [Pa·sec.] (measurement temperature: 290° C., 12.16 [1/sec.]). When the (average) specific resistance of the gut of the resin composition which was not made as pellets, it was 10^{2.31} [Ω·cm].

Using this PET-FCB, melt spinning was carried out by an extruder type melt spinning machine equipped with a twin screw extruder (screw length L/screw diameter D=35) at a spinning temperature of 290° C., setting a die having 24 circular holes and a filter having a mesh fineness of the filter layer of 20μ, and after a water group treatment agent (concentration of effective component: 20 wt. %) was provided so that the effective component was adhered at 1 wt. % relative to the yarn, the melt spinning for drawing the yarn at a draw speed of 1,000 m/min. was tried. However, because yarn breakage occurred frequently at the draw speed of 1,000 m/min. and the drawing could not be carried out at all, the draw speed was reduced down to 200 m/min. but even at the reduced condition, yarn breakage occurred frequently, as a result, the spinning property was very bad and wound yarn could not be obtained.

### Example 1

### Method for Producing Polytrimethylene Terephthalate, Preparation of Polytrimethylene Terephthalate Component Added with CB, Production of Fibers

To a low grade polymer prepared by transesterification carried out by charging dimethyl terephthalate of 130 parts (6.7 parts by mol), 1,3-propanediol of 114 parts (15 parts by mol), calcium acetate hydrate of 0.24 part (0.014 part by mol) and lithium acetate dihydrate of 0.1 part (0.01 part by mol) while removing methanol, trimethylphosphate of 0.065 part and titanium tetrabutoxide of 0.134 part were added, and condensation polymerization was carried out while removing 1,3-propanediol, thereby obtaining chip-like prepolymer. The obtained prepolymer was served to solid phase polymerization at 220° C. under a condition of nitrogen gas flow to prepare a polytrimethylene terephthalate (hereinafter, PTT) pellets having an IV of 1.15, a melt viscosity of 493 [Pa sec.](measurement temperature: 260° C., 12.16 [1/sec.]) and a melting point (Tm) of 229° C.

After the pellets were vacuum dried at 150° C. for 10 hours, in a kneading similar to that in Comparative Example 1, using the same apparatus other than kneading at 250° C. and employing the same kind of FCB and the same content of FCB (16 wt. %), pellets of a resin composition of PTT and FCB (hereinafter, PTT-FCB) having a melt viscosity of 1238 [Pa·sec.] (measurement temperature: 260° C., 12.16 [1/sec.]) was obtained. When the (average) specific resistance of the gut of the resin composition which was not made as pellets, it was 10^{2.21} [Ω·cm].

Using this PTT-FCB, when a spinning experiment was carried out using the same extruder type melt spinning machine as that used in Comparative Example 1 and at the same conditions other than a condition where the spinning temperature was set at 260° C., a non-stretched yarn composed of 24 filaments with a total size of 350 dtex could be wound and obtained at a draw speed of 1,000 m/min. with no problems. There was no problem at all in spinning property, and even in a continuous spinning for 5 hours, any yarn breakage was not observed at all.

Then, when the obtained multifilament was stretched, the yarn (fibers) was applied with stretching, relax and heat treatment at a yarn feeding speed of a yarn feeding roller of 320 m/min., a yarn feeding speed of a first roller of 320 m/min. at 60° C., a yarn feeding speed of a second roller of 800 m/min. at 110° C. and a yarn feeding speed of a third roller of 792 m/min. at a room temperature (1% relax), and after the yarn was cooled by a cooling roller at a temperature of Tg of the polyester or lower, the yarn was wound. Any problems such as winding of a yarn onto a roller did not occur at all, and the stretching property was excellent. The yarn properties are shown in Table 1.

### Examples 2-7 and Comparative Examples 2 and 3

The fibers were obtained at the same yarn forming conditions as those in Example 1 other than conditions where, as shown in Table 1, the amounts of carbon black (Examples 2-5, Comparative Examples 2 and 3), the kinds of carbon black (Example 7, Ketjen black EC produced by Ketjen Black International Corporation, specific resistance: 0.2 [Ω·cm], average particle diameter: 31 nm, hereinafter, KCB) and the thickness of fiber (fiber diameter: 14 μm in Example 6) were changed, and in the spinning process, at the same discharging amount (at an identical volume per a unit time [cc/min.]), and further, with respect to stretching conditions, at the same conditions other than a condition where the temperature of the first roller was changed to 80° C. in Examples 3-5. Even if the kinds of CB and the diameters of fibers were changed, there was no problem in yarn forming property (Examples 6 and 7). Further, as the content of CB increased, although the conductivity was improved in the obtained fiber properties, other properties tended to decrease, and at an excessively high concentration (Comparative Example 2), the specific resistance of the resin composition before melt spinning was very low, the drawing at the melt spinning could not be carried out although a high conductivity was obtained. The yarn properties are shown in Table 1.

TABLE 1

[symbol]

| | | | Compara- | | | | |
|---|---|---|---|---|---|---|---|
| | | | tive | | | | |
| Item | | (Unit) | Example 1 | Example 1 | Example 2 | Example 3 | Example 4 |
| Kind of polymer | | — | PET | PTT | PTT | PTT | PTT |
| Kind of carbon black | | — | furnace | furnace | furnace | furnace | furnace |
| Content of carbon black | | wt % | 16 | 16 | 18 | 25 | 40 |
| Specific resistance | | Ω · cm | 10^{2.31} | 10^{2.21} | 10^{2.10} | 10^{1.65} | 10^{0.89} |
| Fiber | Diameter of | μm | Wound yarn | 23 | 23 | 23 | 23 |
| property | single fiber | | could not | | | | |
| (stretched | Strength | cN/dtex | be obtained. | 2.1 | 1.9 | 1.4 | 0.7 |
| yarn) | Residual | % | | 37 | 30 | 18 | 9 |
| | elongation | | | | | | |
| | Initial tensile | cN/dtex | | 25 | 25 | 26 | 27 |
| | elastic modulus | | | | | | |
| | Dry thermal | % | | 4.5 | 6.5 | 8.4 | 8.5 |
| | shrinkage | | | | | | |
| | Average | Ω/cm | | 10^{11.3} | 10^{9.9} | 10^{4.5} | 10^{1.6} |
| | resistivity (P) | | | | | | |
| | R | — | | 0.38 | 0.23 | 0.08 | 0.03 |
| | Fluctuation of | — | | 1.5 | 1.5 | 1.2 | 1.1 |
| | temperature and | | | | | | |
| | humidity (Z) | | | | | | |

| | | | | Compara- | Compara- | | |
|---|---|---|---|---|---|---|---|
| | | | | tive | tive | | |
| Item | | (Unit) | Example 5 | Example 2 | Example 3 | Example 6 | Example 7 |
| Kind of polymer | | — | PTT | PTT | PTT | PTT | PTT |
| Kind of carbon black | | — | furnace | furnace | furnace | furnace | Ketjen |
| Content of carbon black | | wt % | 50 | 55 | 10 | 18 | 18 |
| Specific resistance | | Ω · cm | 10^{0.73} | 10^{0.69} | 10^{5.1} | 10^{2.10} | 10^{2.05} |
| Fiber | Diameter of | μm | 23 | Wound yarn | 23 | 14 | 23 |
| property | single fiber | | | could not | | | |
| (stretched | Strength | cN/dtex | 0.2 | be obtained. | 3.3 | 1.6 | 1.6 |
| yarn) | Residual | % | 5 | | 45 | 28 | 30 |
| | elongation | | | | | | |
| | Initial tensile | cN/dtex | 27 | | 24 | 25 | 25 |
| | elastic modulus | | | | | | |
| | Dry thermal | % | 10 | | 2.3 | 6.0 | 7.8 |
| | shrinkage | | | | | | |
| | Average | Ω/cm | 10^{0.20} | | 10^{12.6} | 10^{10.9} | 10^{11.2} |
| | resistivity (P) | | | | | | |
| | R | — | 0.04 | | 1.38 | 0.25 | 0.31 |
| | Fluctuation of | — | 1.1 | | 2.1 | 1.6 | 1.8 |
| | temperature and | | | | | | |
| | humidity (Z) | | | | | | |

Fluctuation of temperature and humidity Z (=Y/X): ratio of average resistivity at low temperature and low humidity (10° C., humidity: 15%) (Y) to average resistivity at middle temperature and middle humidity (23° C., humidity: 55%) (X) of conductive fibers
furnace: furnace black produced by Cabot Specialty Chemicals, Inc. (type “VULCAN XC72”)
Ketjen: Ketjen black EC produced by Ketjen Black International Corporation

<Preparation of Isophthalic Copolymerized Polyethylene Terephthalate (Hereinafter, PET/I)>

Pellets of PET/I having an IV of 0.65 and a melt viscosity of 119 [Pa·sec.] (measurement temperature: 290° C., melting point (Tm) of 222° C., 12.16 [1/sec.]) was obtained at the same conditions of Comparative Example 1 other than a condition where terephthalic acid of 150 parts by weight and isophthalic acid of 16 parts by weight were together used instead of terephthalic acid of 1.66 parts by weight in Comparative Example 1. In a case where the PET/I pellets were used for melt spinning, they were used after being vacuum dried at 130° C. for 24 hours.

### Examples 8-10

Conjugate spinning was carried out in a manner similar to the melt spinning of Example 1 to prepare fibers and wind them, and in the conjugate spinning, an extruder type conjugate melt spinning machine equipped with a twin screw extruder (screw length L/screw diameter D=35) was used, and PTT containing FCB at 18 wt. % used in Example 2 (hereinafter, FCB2) (in Examples 8, 10) or PTT containing FCB at 25 wt. % used in Example 3 (hereinafter, FCB3) were used as sheath components, polymers shown in Table 2 (Examples 8, 9: PET/I, Example 10: polytetramethylene terephthalate produced by Toray Industries, Inc. (type: 1100S, melting point (Tm): 225° C., hereinafter, referred to as “PBT”)) were used as core components to prepare conjugate fibers by the conjugate spinning, and the same conditions as those for the melt spinning in Example 1 were employed other than conditions where the spinning temperature of Example 10 was 260° C. and the spinning temperature of Examples 8, 9 was 275° C. When the obtained fibers were further stretched, in Examples 8, 9, the same conditions as those in Example 1 were employed other than conditions where the temperature of the first roller was set at 85° C. and the temperature of the second roller was set at 130° C., and in Example 10, the same conditions as those in Example 1 were employed, and the fibers shown in Table 2 were obtained. Similarly in Examples 1-6, fibers excellent in conductivity and yarn properties could be obtained.

### Examples 11-13

When the melt spinning was carried out similarly in Examples 8-10 using the extruder type conjugate melt spinning machine equipped with the twin screw extruder (screw length L/screw diameter D=35), as the core components for obtaining the core/sheath type conjugate fibers, PTT-FCB3 used in Example 3 was used (Example 11), PTT containing KCB at 25 wt. % used in Example 7 (hereinafter, PTT-KCB2) was used (Example 12), PTT containing FCB at 50 wt. % used in Example 5 (hereinafter, PTT-FCB4) was used (Example 13), and as the sheath components, polymers having fiber forming abilities shown in Table 2 were used (Example 11: PTT, Examples 12, 13: PET/I), and as the spinning temperature for melt spinning, 260° C. was employed for Example 11 and 275° C. was employed for Examples 12, 13, and employing the same conditions as those in Example 1 as the other conditions, the melt spinning was carried out to obtain and wind the fibers. When the obtained fibers were further stretched, in Example 11, the same conditions as those in Example 1 were employed, and in Examples 12 and 13, the same conditions as those in Example 1 were employed other than conditions where the temperature of the first roller was set at 85° C. and the temperature of the second roller was set at 130° C., and the fibers shown in Table 2 were obtained. In Example 12, the fibers having about the same diameter of single fiber, and in Example 13, the fibers having a large diameter of single fiber, were obtained, respectively. Similarly in Examples 1-10, fibers having high conductivity and excellent yarn properties could be obtained, even if the fiber surfaces were covered with the polymers having fiber forming abilities.

### Example 14

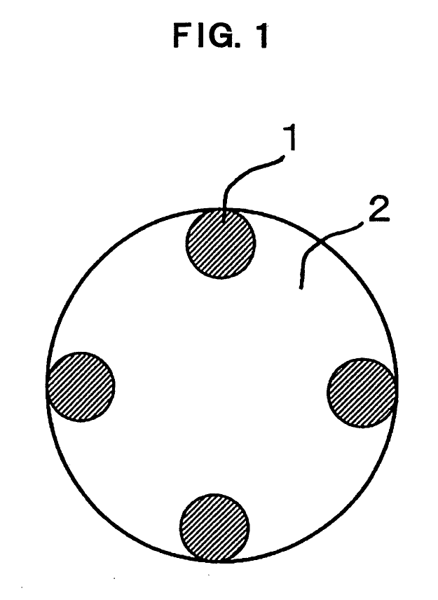

When the conjugate spinning was carried out similarly in Example 8, PTT-FCB was disposed at four positions on the fiber surface layer as shown in FIG. 1, the melt spinning was carried out at the same conditions as those in Example 8 other than a condition where PET was used as the polymer having a fiber forming ability and the conjugate spinning was carried out at a spinning temperature of 285° C., and the stretching was carried out at the same condition as that in Example 9 to obtain the fibers having properties shown in Table 2. Although the unevenness of conductivity (standard deviation) of the obtained fibers became slightly greater as compared with those in Examples 8-10, the fibers having a good conductivity were obtained.

### Example 15

When the melt spinning similar to that in Example 1 was carried out, non-stretched yarn was obtained by a melt spinning at the same conditions as those in Example 1 other than conditions where a material dry blended beforehand at a pellet condition so as to achieve a volume rate of PTT-FCB3:PET=30:70 was used and the melt spinning was carried out at 275° C. using the extruder type melt spinning machine. The non-stretched yarn was stretched at the same condition as that in Example 9 to obtain the fibers having fiber properties shown in Table 2. The obtained fibers had a good conductivity.

TABLE 2

[symbol]

| Item | | (Unit) | Example 8 | Example 9 | Example 10 | Example 11 | Example 12 | Example 13 | Example 14 | Example 15 |
|---|---|---|---|---|---|---|---|---|---|---|
| Kind of polymer | | — | PTT | PTT | PTT | PTT | PTT | PTT | PTT | PTT |
| Kind of carbon black | | — | furnace | furnace | furnace | furnace | Ketjen | furnace | furnace | furnace |
| Content of carbon black | | wt % | 18 | 25 | 18 | 25 | 25 | 50 | 18 | 25 |
| Specific resistance | | Ω · cm | 10^{2.10} | 10^{1.65} | 10^{2.10} | 10^{1.65} | 10^{1.43} | 10^{0.73} | 10^{2.10} | 10^{1.65} |
| Disposition of PPT | | | sheath | sheath | sheath | core | core | core | island, | — |
| containing CB in | | | | | | | | | exposed on | |
| composite fiber | | | | | | | | | surface layer | |
| Fiber | Kind of | — | PET/I | PET/I | PBT | PTT | PET/I | PET/I | PET | PET/I |
| Property | polymer having | | | | | | | | | |
| | fiber forming | | | | | | | | | |
| | ability | | | | | | | | | |
| | Type of | — | core/ | core/ | core/ | core/ | core/ | core/ | conjugate | blend |
| | conjugate | | sheath | sheath | sheath | sheath | sheath | sheath | (FIG. 1) | |
| | Rate of | vol. % | 30 | 20 | 50 | 80 | 90 | 15 | 20 (each | 30 |
| | conductive layer | | | | | | | | island is 5) | |
| | Diameter of | μm | 23 | 23 | 24 | 23 | 14 | 38 | 23 | 23 |
| | single fiber | | | | | | | | | |
| | Strength | cN/dtex | 3.8 | 3.6 | 2.6 | 2.8 | 2.1 | 4.1 | 4.0 | 3.5 |
| | Residual | % | 43 | 37 | 33 | 41 | 32 | 38 | 33 | 23 |
| | elongation | | | | | | | | | |
| | Initial tensile | cN/dtex | 52 | 59 | 24 | 25 | 30 | 65 | 60 | 50 |
| | elastic modulus | | | | | | | | | |
| | Dry thermal | % | 4.5 | 2.3 | 4.1 | 5.1 | 3.4 | 3.1 | 2.1 | 3.3 |
| | shrinkage | | | | | | | | | |
| | Average | Ω/cm | 10^{9.9} | 10^{6.0} | 10^{10.1} | 10^{11.1} | 10^{10.1} | 10^{11.2} | 10^{9.8} | 10^{7.0} |
| | resistivity (P) | | | | | | | | | |
| | R | — | 0.10 | 0.09 | 0.21 | 0.35 | 0.21 | 0.32 | 0.67 | 0.18 |
| | Fluctuation of | — | 1.4 | 1.3 | 1.4 | 1.1 | 1.1 | 1.2 | 1.2 | 1.2 |
| | temperature and | | | | | | | | | |
| | humidity (Z) | | | | | | | | | |

Fluctuation of temperature and humidity Z (=Y/X): ratio of average resistivity at low temperature and low humidity (10° C., humidity: 15%) (Y) to average resistivity at middle temperature and middle humidity (23° C., humidity: 55%) (X) of conductive fibers
furnace: furnace black produced by Cabot Specialty Chemicals, Inc. (type “VULCAN XC72”)
Ketjen: Ketjen black EC produced by Ketjen Black International Corporation
R: ratio (R = Q/P) of standard deviation of resistivity (Q) to average resistivity (P)

### Example 16

Using the fibers obtained in Examples 1, 3, 7, 9, 12, 14 and 15, after the respective fibers were cut to short fibers having average fiber lengths of 0.5, 1.0 and 2.0 mm, respectively, they were treated by colloidal silica “Snowtex OS” (registered trade mark) produced by Nissan Kagaku Kogyo K.K., an acrylic ester group adhesive “DICNAL K-1500” (“DICNAL VS-20” was used as thickener at 2 wt. % relative to 100 wt. % of “K-1500”, hereinafter, also referred to as “adhesive A”) produced by Dainippon Ink Chemical Corporation was applied at a thickness of about 100 μm onto one surface of a polyester film “LUMIRROR” (registered trade mark) qt33 (THICKNESS: 100 μm) produced by Toray Industries, Inc., and an electric flocking was carried out to the one surface of the film applied with the adhesive to make a flocked material. As to the flocking property (degree of success of flocking), when determined by observation based on ranks of “almost standing up perpendicularly (double circle)”, “lying fibers are slightly observed (∘)”, “about half of fibers are lying (□)” and “fibers standing up perpendicularly are few (x)”, the flocked materials were all determined to be double circle, and they were excellent.

Further, after twisting was carried out using the respective fibers obtained in Examples 2, 6, 8, 10, 11 and 13 to prepare pile woven fabrics and kit fabrics, respectively, they were served to raising treatment, and using the adhesive A similarly as described above, they were adhered to the above-described polyester films to make respective fabric composites. Similarly as described above, the raising properties were all excellent.

### Example 17

Woven fabrics were prepared at a weave density of 150 yarns/inch using the fibers obtained in Examples 3, 4, 5, 9 and 13 as warp yarns and weft yarns, and for each woven fabric, a fabric material having a length of 20 cm was prepared as a wire product by providing electrodes to both ends so that the length of each electrode became 20 cm and the width became 5 cm, and when a voltage of 100V was applied between the both electrodes, the respective wire products became heating units which elevated in temperature at temperature elevation speed of 1.2° C./min., 3.8° C./min., 4.9° C./min., 0.8° C./min. and 3.2° C./min., respectively.

### Example 18

Using the fibers obtained in Examples 1, 2, 3, 6, 7, 8, 9, 10, 11, 12, 13 and 15, short fibers having an average fiber length 2 mm were prepared, and using the adhesive A of Example 16, electric flocking was carried out to a metal rod material A comprising SUS304 and a metal rod material B comprising SUS304 in which urethane intermediate layer added with conductive carbon black at a content of 5% was provided (for the metal rod material B, the electric flocking carried out only to the intermediate layer), respectively, and after wiping off non-adhered short fibers from the respective rod materials, brush rollers were obtained (A1, A2, A3, A6, A7, A8, A9, A10, All, A12, A13, A15, B1, B2, B3, B6, B7, B8, B9, B10, B11, B12, B13, B15). Further, using the fibers obtained in Examples 1, 2, 3, 6, 7, 8, 9, 10, 11, 12, 13 and 15, pile woven fabrics were prepared by using twisted fibers similarly to that in Example 16 and piles were raised, and the raised pile woven fabrics were slit at a width of 1 cm and the slit materials were wound onto the above-described metal rod materials A to obtain brush rollers (C1, C2, C3, C6, C7, C8, C9, C10C, C11, C12, C13, C15).

### Example 19

Among the brush rollers obtained in Example 18, C1, C2, C6, C7, C8, C10, C11, C12 and C13 were incorporated, respectively, into a cleaning device in a laser beam monochroic printer, and when the printer was continuously operated for printing (10 sheets per one minute printing and discharge) and the printing property and fluctuation of humidity in the printer were confirmed, at the time of about 1,000 sheets after start of the printing, the humidity in the printer decreased from 65% to 31%, and at the time of further 1,000 sheets printing, decreased down to 25%, but, even if the number of the printed sheets exceeded 20,000, the clearness of printing, cleaning property of toner, etc. were excellent. Further, as to C3, C9 and C15 among the brush rollers, when they were similarly investigated by incorporating them into an electrostatic charging device, respectively, also even at the time when the number of the printed sheets exceeded 30,000, the clearness of printing was excellent.

### Example 20

Using the respective fibers obtained in Examples 1-15, as one embodiment, they were used only as the weft yarns and shirts were made from plain weave fabrics (clothes A1-A15). As another embodiment, the fibers obtained in Examples 1-15 were used as all the warp and weft yarns and shirts were made (clothes B1-B15). As the result of monitor wearing test bay randomly selected 10 male persons, all persons answered to “feel cold when wearing (there is a contact cold feeling)” for all of clothes A1-A15 and clothes B1-B15, and as to six clothes of clothes A3-A5 and clothes B3-B5, all persons answered to “feel very cold when wearing (there is a strong contact cold feeling)”.

### Example 21

Using the fibers obtained in Comparative Example 3 and Examples 1, 3, 9, 13, 14 and 15, carpets (size: 1 m×1 m) were made mainly from nylon 6 containing these fibers at 10 wt. %, and as the result of an experiment in which foot steps at a condition wearing leather shoes of synthetic leather applied with no conductive treatment were repeated by 100 times in an atmosphere at 23° C. and a humidity of 55% and thereafter the person contacted with a metal doorknob at a condition where he was staying on the carpet, although an electric discharge due to generation of static electricity occurred only in a case of the fibers obtained in Comparative Example 3, discharge of static electricity did not occur in cases of the fibers obtained in Examples 1, 3, 9, 13, 14 and 15.

As described hereinabove, because the woven fabric comprising the polyester fibers as at least part thereof uses fibers having a very excellent conductivity as aforementioned, the fabric becomes a woven fabric having an excellent conductive performance or an excellent performance capable of escaping electricity (in other words, electrostatic performance) certainly in a case where the fibers are used for the whole of the woven fabric and even in a case where the fibers are used as part of the woven fabric, and therefore, the fabric can be used for various material uses, for example, for screens, curtains, seats of carriages such as cars, trains or air planes which tend to provide static electricity to human body, wall materials, carpets, or bedclothes such as quilts, blankets or bed sheets, and can exhibit excellent performances.

Further, because the knit fabric comprising the polyester fibers as at least part thereof becomes a knit fabric having a conductive performance or an electrostatic performance similarly to the case of the above-described woven fabric, the fabric can be used for various material uses, for example, for wall materials for buildings, mats such as carpets, seats of carriages such as cars, trains or air planes or mats thereof, or bedclothes such as quilts, blankets or bed sheets, and can exhibit excellent performances.

Further, because the nonwoven fabric comprising the polyester fibers as at least part thereof becomes a nonwoven fabric having a conductive performance or an electrostatic performance similarly to the cases of the above-described woven fabric and knit fabric, the fabric can be used as various materials similar to those for the above-described woven fabric and knit fabric, and other than those, the fabric can be broadly used as materials requiring a thickness such as partition materials or packaging materials, devices hating occurrence of static electricity such as cushions, or materials for peripheral members of rooms, and can exhibit excellent performances.

As other uses of the short fibers, woven fabric, particularly pile woven fabric, knit fabric or nonwoven fabric comprising the polyester fibers, flocked materials or fabric composites can be formed by using them and flocking them to substrates. These flocked materials or fabric composites can become various interior materials as materials having an excellent touch feeling because of excellent conductivity or anti-electrostatic property.

Further, the polyester fibers or the short fibers comprising the conductive fibers are excellent in conductivity, and can form wire materials, and the wire materials can be used, for example, as a part of the circuit of an actuator such as an artificial muscle capable of operating by a fine current and operating various movements, Alternatively, a heating unit can be formed from the wire material, and because this is excellent in conductivity and uses the polyester fibers having a small unevenness of conductivity, merely by the material controlled to a desirable conductive performance, an excellent heating unit good in heating efficiency can be obtained. Further, although it is low temperature and low humidity in winter season in which the heating unit would be mainly used, because the polyester fibers have no or very small dependency on temperature and humidity, even in winter season, a stable conductive performance can be exhibited, and a very excellent heating unit can be realized.

Further, because the clothing comprising the polyester fibers as at least part thereof uses fibers having an excellent conductivity, the occurrence of static electricity at the time of wearing can be suppressed, and it can be escaped outside human body. Therefore, it is particularly useful to use it as a working cloth for semiconductor field hating occurrence of static electricity or as a dustproof cloth because static electricity hardly occurs and dust is not attracted. Further, because CB is excellent in thermal conductivity, it is useful as a contact cold feeling cloth capable of radiating heat to outside of human body, a contact warm feeling cloth capable of immediately taking heat into cold human body from outside of human body, etc. For example, it can be suitably used for clothing requiring these functions such as sport clothes (golf wears, uniforms for baseball, tennis, soccer, pingpong, volleyball, basketball, Rugby, American football, hockey, athletic sports, triathlon, speed skate, ice hockey, etc.), clothes for babies, women or old people, and other than those, outdoor clothes (shoes, bags, supporters, socks, mountain-climbing clothes, etc.), etc.

Further, in the polyester fibrous brush roller using and adhering, at least as part thereof, the aforementioned woven fabric and/or knit fabric and/or nonwoven fabric which uses the polyester fibers at least as part thereof, because the fibers having a conductivity are used at least a part, by utilizing the electric operation of the conductive fibers, the brush roller has a function for efficiently removing unnecessary substances or providing necessary substances, and it can exhibit an excellent performance.

Further, in the polyester fibrous brush roller using the short fibers comprising the polyester fibers, because the fibers having a conductivity are used at least a part, similarly to the case described above, it is excellent in that, by utilizing the electric operation of the conductive fibers, the brush roller can have a function for efficiently removing unnecessary substances or providing necessary substances. Further, it is also excellent in that, by controlling the fiber length of the short fibers, the fiber flocking density of the brush roller or the above-described removing performance or providing performance of the fibrous brush roller can be easily controlled in accordance with the purpose. In particular, in a case where the rod material to be flocked comprises mainly a metal, the conductivity (specific resistance) of the fibrous brush roller itself can be controlled by controlling the conductivity of the polyester fibers, and further, in a case where the rod material comprises a metal and an intermediate layer covering at least part of the metal, a cushion property can be given by controlling the material, the thickness, etc. of the intermediate layer. Therefore, the above-mentioned removing performance or providing performance of the fibrous brush roller itself can be remarkably improved, and an excellent performance can be exhibited.

Further, the cleaning device using the above-described polyester fibrous brush roller is very excellent in removing performance in a case where unnecessary substances are removed and cleaned, by rotation of the brush roller itself. For example, in an electrophotographic device, etc., even in a case when there is an environmental fluctuation in the electrophotographic device when toner and the like can be electrically removed, in particular, even in a case where there is a humidity fluctuation and the like, because the performance of the brush roller does not fluctuate, a stable removing performance is always exhibited and such a state is excellent. Further, in the cleaning device, the above-described brush roller cleans the substances to be cleaned, for example, in the electrophotographic device, cleans the photoreceptor by a direct contact thereto, and other than that, it is useful as a member for removing unnecessary substance from the member itself performing cleaning action and cleaning the cleaning device itself, and consequently, a high-performance cleaning device is realized.

Further, the electrostatic charging device using the above-described polyester fibrous brush roller is used by controlling the conductivity (specific resistance) of the brush roller itself, and it is excellent, for example, because a photoreceptor can be charged uniformly when it is used as a brush roller in an electrophotographic device for uniformly charging the photoreceptor. Further, because the specific resistance of the brush roller itself has no fluctuation or a very small fluctuation even against an environmental fluctuation in the electrophotographic device, for example, humidity fluctuation during operation of the electrophotographic device or due to season change, it is also excellent in that an unevenness of electric charge of the photoreceptor hardly occurs. Further, in a case where there is residual colorant (toner) in the above-described photoreceptor of the electrophotographic device because of insufficient cleaning, since the brush roller also can function as a cleaning roller, it is excellent in that there is no or almost no soil at the time of developing or printing. In addition, in a case where the electrophotographic device is made small, it can exhibit a very excellent performance because a cleaning and electric charging device can be realized only by the brush roller without installing the above-described cleaning device and the electric charging device separately.

Further, the developing device using the above-described polyester fibrous brush roller is used by utilizing the conductivity of the brush roller itself similarly to the advantage in the above-described electric charging device, and for example, when toner is adhered to the electrostatic latent image depicted on the photoreceptor in the electrophotographic device, etc., there is no or almost no unevenness of the specific resistance of the brush roller itself at the time of an environmental fluctuation such as the above-mentioned humidity fluctuation. Therefore, the toner is supplied uniformly to the photoreceptor for the image actualization, and the developed or printed material obtained becomes a very beautiful material in which there is no or almost no soil and an excellent performance can be exhibited.

Further, in the electrostatic removing device using the above-described polyester fibrous brush roller, a brush roller having a very excellent electrostatic removing performance can be realized by making the conductivity (specific resistance) of the brush roller small by controlling the content of conductive carbon black contained in the fibers, and it is useful. In particular, when used for an electrophotographic device, because the brush roller comprising a number of feathers (fibers) exhibits a stable and uniform electrostatic removing effect, the cleaning effect at the above-described cleaning device disposed after the electrostatic removing device can be further enhanced. Further, in a case of making the electrophotographic device small, an electrostatic removing and cleaning device can be incorporated by using the brush roller, and it is very excellent.

Furthermore, in an electrophotographic device using the above-described cleaning device and/or electrostatic charging device and/or developing device and/or electrostatic removing device which uses the polyester fibers at least as part thereof, concretely, in a device for carrying out developing or printing by a mechanism for depicting a latent image on a charged photoreceptor by a laser and actualizing the image using toner, such as a laser beam printer, a copy machine, a facsimile machine, a multifunctional composite machine, a word processor, etc., as aforementioned, because stable cleaning, electrostatic charging, developing and electrostatic removing performances are exhibited irrelevant to environmental fluctuation in the electrophotographic device, the obtained printed or developed material becomes very beautiful. Further, because more stable cleaning, electrostatic charging, developing and electrostatic removing performances are exhibited by optimizing the fiber length of the fibrous brush roller or the content of conductive carbon black contained, it becomes possible to further improve the driving speed of the electrophotographic device, namely, to increase the printing or developing speed (number of sheets) per unit time, and it is very preferable.

### INDUSTRIAL APPLICATIONS

Thus, the polyester fibers and the textile products comprising the same can be suitably used for various uses required with excellent conductivities, for various uses required with stable conductivities against humidity fluctuation, etc., and further, for various uses required with other performances, for example, electrostatic removing performance or electrostatic charging performance.

1. Polyester fibers comprising a polyester resin composition which comprises carbon black and trimethylene terephthalate units as main repeating structural units, said polyester fibers having an average resistivity (P) of 1.0×10¹² [Ω/cm] or lower.

2. The polyester fibers according to claim 1, wherein said polyester resin composition forms at least part of surfaces of said fibers.

3. The polyester fibers according to claim 1, wherein a ratio (R) (R=Q/P) of a standard deviation of resistivity (Q) to said average resistivity (P) is 0.5 or less.

4. The polyester fibers according to claim 1, wherein a ratio (Z) (Z=Y/X) of an average resistivity at a temperature of 10° C. and a humidity of 15% (Y) [Ω/cm] to an average resistivity at a temperature of 23° C. and a humidity of 55% (X) [Ω/cm] is in a range of 1-5.

5. The polyester fibers according to claim 1, wherein an initial tensile elastic modulus is in a range of 15-80 cN/dtex.

6. The polyester fibers according to claim 1, wherein a content of carbon black in said polyester resin composition is 15 wt. % or more and 50 wt. % or less.

7. The polyester fibers according to claim 1, wherein said polyester fibers are short fibers having a fiber length of 0.05-150 mm.

8. The polyester fibers according to claim 1, wherein a specific resistance of said polyester resin composition is 1.0×10⁴ [Ω·cm] or lower.

9. A polyester textile product at least part of which comprises polyester fibers according to claim 1.

10. The polyester textile product according to claim 9, wherein said polyester textile product is a fibrous brush.

11. The polyester textile product according to claim 10, wherein said fibrous brush is a brush for electrophotographic devices.
